(19) United States
(12) Patent Application Publication
(10) Pub. No.: US 2024/0381273 A1
(43) Pub. Date: Nov. 14, 2024

(54) COMMUNICATION METHODS AND COMMUNICATION APPARATUS

(71) Applicant: SPREADTRUM COMMUNICATIONS (SHANGHAI) CO., LTD., Shanghai (CN)

(72) Inventors: Huayu ZHOU, Shanghai (CN); Zhenzhu LEI, Shanghai (CN); Miao WANG, Shanghai (CN); Zhengang PAN, Shanghai (CN)

(21) Appl. No.: 18/687,997

(22) PCT Filed: Aug. 27, 2022
(86) PCT No.: PCT/CN2022/115324

§ 371 Date: Feb. 29, 2024

(30) Foreign Application Priority Data
Aug. 31, 2021 (CN) 202111017214.6

(51) Int. Cl. H04W 56/00; H04W 52/02

(52) U.S. Cl. CPC H04W 56/0015; H04W 52/0206

(57) ABSTRACT

Communication methods and communication apparatus are provided. A communication method is performed by a user equipment (UE) and includes: receiving, within one period of a synchronization signal burst, N1 synchronization signal bursts, where N1 is an integer greater than 1.

### CROSS-REFERENCE TO RELATED APPLICATION(S)

This application is a National Stage of International Application No. PCT/CN2022/115324, field Aug. 27, 2022, which claims priority to Chinese Patent Application No. 202111017214.6, filed Aug. 31, 2021, the entire disclosures of which are hereby incorporated by reference.

### TECHNICAL FIELD

This application relates to the field of communication technology, and particularly to communication methods and communication apparatus.

### BACKGROUND

Network energy saving (or network power saving) has become a concern for operators and equipment manufacturers. Network energy saving is beneficial to reducing operating costs and promoting environmental protection. Since there are many spectrum resources in 5G networks, such as 1 GHz, 2 GHZ, 4 GHZ, 6 GHZ, 26 GHz, and other frequency bands, when a network load is low, a network device can shut down transmission of signals and/or channels of carriers or cells corresponding to some frequency bands as much as possible, to achieve network energy saving. How to achieve network energy saving while ensuring communication quality has become an urgent problem to-be-solved.

### SUMMARY

In a first aspect, implementations of the disclosure provide a communication method. The communication method is performed by a user equipment (UE) and includes: receiving, within one period of a synchronization signal burst, N1 synchronization signal bursts, N1 being an integer greater than 1.

In a second aspect, implementations of the disclosure provide a communication method. The communication method is performed by a UE and includes: determining that a synchronization signal burst and/or a reference signal burst within a first window are valid.

In a third aspect, implementations of the disclosure provide a communication apparatus. The communication apparatus includes a transceiver, a processor, and a memory. The processor is in communication connection with the transceiver. The memory is in communication connection with the processor and stores instructions executable by the processor. The instructions, when executed by the processor, are operable with the processor to execute the method in the first aspect.

### BRIEF DESCRIPTION OF THE DRAWINGS

In order to describe technical solutions of implementations of the disclosure or the related art more clearly, the following will give a description of accompanying drawings used for describing the implementations or the related art.

FIG. 1 is a schematic architecture diagram illustrating a communication system provided in the disclosure.

FIG. 2 is a flowchart illustrating a communication method provided in implementations of the disclosure.

FIG. 3 is a flowchart illustrating a communication method provided in other implementations of the disclosure.

FIG. 4 is a flowchart illustrating a communication method provided in other implementations of the disclosure.

FIG. 5 is a flowchart illustrating a communication method provided in other implementations of the disclosure.

FIG. 6 is a flowchart illustrating a communication method provided in other implementations of the disclosure.

FIG. 7 is a schematic structural diagram illustrating a communication apparatus provided in implementations of the disclosure.

FIG. 8 is a schematic structural diagram illustrating a communication apparatus provided in other implementations of the disclosure.

FIG. 9 is a schematic structural diagram illustrating a communication apparatus provided in other implementations of the disclosure.

FIG. 10 is a schematic structural diagram illustrating a communication apparatus provided in other implementations of the disclosure.

FIG. 11 is a schematic structural diagram illustrating a communication apparatus provided in other implementations of the disclosure.

FIG. 12 is a schematic structural diagram illustrating a communication apparatus provided in other implementations of the disclosure.

FIG. 13 is a schematic structural diagram illustrating a communication apparatus provided in other implementations of the disclosure.

FIG. 14 is a schematic structural diagram illustrating a communication apparatus provided in other implementations of the disclosure.

FIG. 15 is a schematic structural diagram illustrating a communication apparatus provided in other implementations of the disclosure.

FIG. 16 is a schematic structural diagram illustrating a communication apparatus provided in other implementations of the disclosure.

FIG. 17 is a schematic structural diagram illustrating a communication apparatus provided in other implementations of the disclosure.

FIG. 18 is a schematic structural diagram illustrating a communication apparatus provided in other implementations of the disclosure.

### DETAILED DESCRIPTION

The terms “first”, “second”, and the like used in the specification, the claims, and the accompany drawings of the disclosure are only used to distinguish different objects rather than describe a particular order. In addition, the terms “include”, “comprise”, and “have” as well as variations thereof are intended to cover non-exclusive inclusion. For example, a process, method, system, product, or device including a series of operations or units is not limited to the listed operations or units, on the contrary, it can optionally include other operations or units that are not listed; alternatively, other operations or units inherent to the process, method, product, or device can be included either.

The terms used in the following implementations of the disclosure are only for describing specific implementations, and are not intended to limit the disclosure. As used in the specification and the appended claims of the disclosure, singular expressions such as “a/an”, “one”, “the”, “above”, “said”, and “this” are intended to also include plural expressions, unless the context expressly indicates the contrary. It should also be understood that, the term “and/or” used in the disclosure refers to including any possible combination or all possible combinations of one or more listed items. For example, “A and/or B” means three situations, that is, A alone, both A and B, or B alone, where A and B may be singular or plural. The terms “a plurality of” or “multiple” used in the disclosure refer to two or more than two.

The term “implementation” referred to herein means that particular features, structures, or properties described in conjunction with the implementations may be defined in at least one implementation of the disclosure. The phrase “implementation” appearing in various places in the specification does not necessarily refer to the same implementation or an independent/alternative implementation that is mutually exclusive with other implementations. Those skilled in the art will understand expressly and implicitly that an implementation described herein may be combined with other implementations.

The network architecture involved in the disclosure will be depicted in detail below.

Technical solutions provided in the disclosure can be applied to various communication systems, such as a long term evolution (LTE) system, an LTE frequency division duplex (FDD) system, an LTE time division duplex (TDD) system, a universal mobile telecommunication system (UMTS), a worldwide interoperability for microwave access (WiMAX) communication system, a fifth generation (5G) communication system or new radio (NR), other future communication systems such as a sixth generation (6G) system, etc. The communication system to which the technical solutions provided in the disclosure are applicable includes at least two entities. One entity (e.g., a base station) can send a synchronization signal and/or a reference signal, and another entity (e.g., user equipment) can receive the synchronization signal and/or the reference signal. It should be understood that, the technical solutions provided in the disclosure can be applicable to any communication system including said at least two entities.

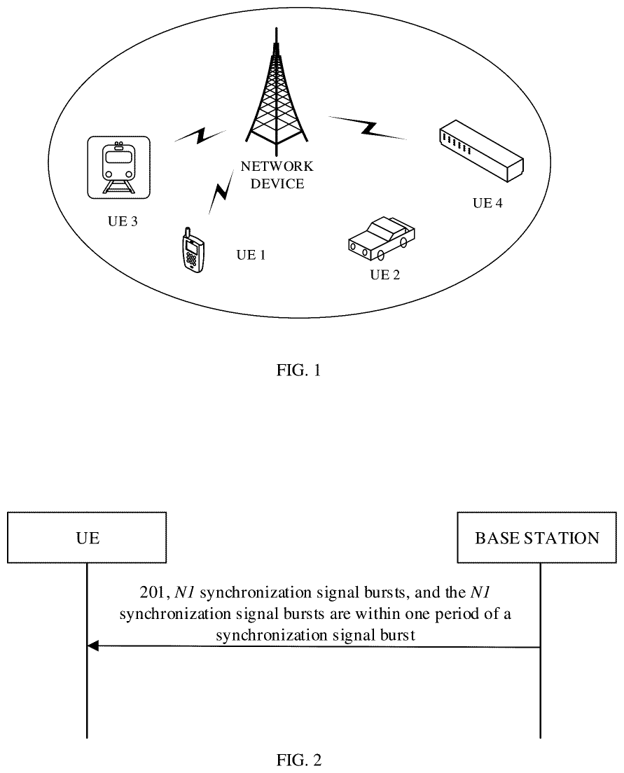

Referring to FIG. 1, FIG. 1 is a schematic architecture diagram illustrating a communication system provided in the disclosure. As illustrated in FIG. 1, the communication system includes one or more network devices (e.g., base stations) and one or more user equipment (UE) connected with the network device(s). In FIG. 1, one network device and four UEs are shown as an example, that is, the four UEs are UE 1 to UE 4.

The network device herein may be a device that can communicate with a UE. The network device may be any device with a wireless transceiver function. The network device may be a base station, an access point (AP), a transmission reception point (TRP), or a device communicating with a UE through one or more cells via an air interface, which is not limited in the disclosure. For example, the base station may be an evolved NodeB (eNB or eNodeB) in LTE, a relay station, an AP, a next generation NodeB (gNB) in a 5G network, etc. It can be understood that, the base station may also be a base station in a future evolved public land mobile network (PLMN), etc.

Optionally, the network device may also be an access node, a wireless relay node, a wireless backhaul node, and the like in a wireless fidelity (WiFi) system.

Optionally, the network device may also be a wireless controller in a cloud radio access network (CRAN) scenario.

For ease of description, the following will take a base station as an example to illustrate the network device involved in the disclosure. Optionally, in some deployments of the base station, the base station may include a centralized unit (CU), a distributed unit (DU), etc. In other deployments of the base station, the CU may also be divided into a CU-control plane (CP) and a CU-user plane (UP). In other deployments of the base station, the base station may also be an open radio access network (ORAN) architecture, etc. The disclosure does not limit the specific deployment of the base station.

The UE can be called a terminal device. The UE of the disclosure may be a device with a wireless transceiver function, and can communicate with one or more core network (CN) devices (or called “core device”) via a network access device (or called “access device”) in a radio access network (RAN). The UE can send an uplink signal to the network device and/or receive a downlink signal from the network device. The UE may include a mobile phone, a car, a tablet computer, a smart speaker, a train detector, a gas station, etc. Main functions of the UE include collecting data (certain UEs), receiving control information and downlink data from the network device, and sending uplink data to the network device. Optionally, the UE may also be called an access terminal, a terminal, a subscriber unit, a subscriber station, a mobile station, a remote station, a remote terminal, a mobile device, a user terminal, a wireless network device, a user agent, a user device, etc. Optionally, the UE may be deployed on land, including indoors or outdoors, and may be handheld or vehicle-mounted; the UE may also be deployed on water (e.g., a ship); the UE may also be deployed in the air (e.g., an aircraft, a balloon, or a satellite). Optionally, the UE may be a handheld device with a wireless communication function, a vehicle-mounted device, a wearable device, a terminal in the Internet of Things or the Internet of Vehicles, any form of terminal in a 5G network or a future network, etc. which is not limited in the disclosure.

Optionally, in the communication system illustrated in FIG. 1, UEs can also communicate with each other through technologies such as device-to-device (D2D), vehicle-to-everything (V2X), or machine-to-machine (M2M), and the disclosure does not limit the communication method between UEs.

In the communication system illustrated in FIG. 1, the network device and any UE can be configured to execute the method provided in implementations of the disclosure.

First, a synchronization signal block (SSB) in Rel-15 NR will be introduced.

In Rel-15 NR, a synchronization signal and a broadcast channel are sent in the form of an SSB, and a beam sweeping function is introduced. A primary synchronization signal (PSS), a secondary synchronization signal (SSS), and a physical broadcast channel (PBCH) are in an SSB/PBCH block. Each SSB can be regarded as a resource of a beam (analog domain) in a beam sweeping process. Multiple SSBs form a synchronization signal burst (SS-burst). The SS-burst can be regarded as a relatively concentrated resource of multiple beams. The SS-burst can also be referred to as SSB burst. The SSB being repeatedly sent on different beams refers to a beam sweeping process. Through beam sweeping training, the UE can know on which beam the strongest signal is received.

The time domain positions of L SSBs within a 5 ms window are fixed. The indexes of L SSBs are continuous in the time domain position, from 0 to L−1. Therefore, the sending time of an SSB within the 5 ms window is fixed, and the index of the SSB is also fixed.

Remaining minimum system information (RMSI) in Rel-15 NR will be introduced.

RMSI in Rel-15 NR is equivalent to a system information block 1 (SIB1) in LTE, and RMSI includes main system information other than a master information block (MIB). RMSI can also be referred to as SIB1. RMSI is carried on a physical downlink shared channel (PDSCH), and PDSCH is scheduled through a physical downlink control channel (PDCCH). PDSCH carrying RMSI is generally called RMSI PDSCH, and PDCCH for scheduling RMSI PDSCH is generally called RMSI PDCCH.

Generally, a search space set contains PDCCH monitoring occasion, search space type, etc. The search space set is generally bound to a control resource set (CORESET), and CORESET contains a duration and a frequency domain resource of PDCCH.

A search space set where RMSI PDCCH is located is generally called Type0-PDCCH search space set. Generally, Type0-PDCCH search space set configured by MIB or configured by radio resource control (RRC) in handover is called search space 0 (or search space set 0), and CORESET bound to said Type0-PDCCH search space set is called CORESET 0. In addition to the RMSI PDCCH search space set, other public search spaces or other public search space sets, such as an open system interconnection (OSI) PDCCH search space set (TypeOA-PDCCH search space set), a random access response (RAR) PDCCH search space set (Type1-PDCCH search space set), a paging PDCCH search space set (Type2-PDCCH search space set), may be the same as search space set 0 by default. Generally, the above public search spaces or public search space sets can be reconfigured.

RMSI PDCCH monitoring occasion has an association relationship with an SSB. The UE obtains the association relationship according to a RMSI PDCCH monitoring occasion table. In initial access, the UE finds a certain SSB, and the UE determines a time domain position (a starting symbol index or a first symbol index) of an RMSI PDCCH associated with said SSB according to a row index of a table indicated by a PBCH, so that the RMSI PDCCH can be detected, and the RMSI PDSCH can be received and decoded according to scheduling of the RMSI PDCCH.

Obtaining of timing information by the UE based on an SSB will be introduced.

The UE needs to obtain timing information based on an SSB. The timing information can also be referred to as frame timing information or half-frame timing information, and generally indicates timing of a frame or a half frame corresponding to a detected synchronization signal. After obtaining the frame timing information, the UE obtains complete timing information of a cell corresponding to an SSB through system frame number (SFN). After obtaining the half-frame timing information, the UE obtains complete timing information of a cell corresponding to an SSB through a half-frame indication (first half frame or second half frame) and SFN.

Generally, the UE obtains the timing information within 10 milliseconds by obtaining an SSB index. In licensed spectrums, the SSB index is related to L candidate positions of SSBs. When L=4, two least significant bits (LSB) of the SSB index are carried by a PBCH demodulation reference signal (PBCH-DMRS); when L>4, three LSBs of the SSB index are carried by a PBCH-DMRS; when L=64, three most significant bits (MSB) of the SSB index are carried by a PBCH payload or an MIB.

Rate matching and time domain resource allocation of an RMSI PDSCH will be introduced.

In Rel-15 NR, the UE decodes the RMSI PDCCH to obtain multiple bits for time domain resource allocation, and obtains a starting symbol index (or serial number) and a symbol length (or duration) of the RMSI PDSCH by searching a predefined table based on these bits.

In Rel-15 NR, during initial access of the UE, the UE assumes that no RMSI PDSCH rate matching is performed for the SSB. The RMSI can indicate information about whether an SSB has been sent. After obtaining the RMSI, the UE performs rate matching around the SSB indicated by the RMSI.

Paging PDCCH monitoring occasion will be introduced.

In Rel-15 NR, for a given UE, paging occasion (PO) corresponding to the UE consists of multiple paging PDCCH monitoring occasions. Within a PO, the paging PDCCH can be sent through beam sweeping, just as the SSB. Within a PO, the paging PDCCH monitoring occasion is in one-to-one correspondence with the SSB, that is, within a PO, the Kth paging PDCCH monitoring occasion corresponds to the Kth SSB.

Initial access of new radio (NR) will be introduced.

In NR, a UE is generally a UE that supports a 100 MHz bandwidth. During initial access, the UE blindly detects PSS/SSS/PBCH in an SSB, and obtains time index information and MIB carried on a PBCH. The UE obtains, according to information in the MIB, configuration of CORESET (or called CORESET0) and a search space set (or called search space set 0) of CORESET for scheduling SIB1. Further, the UE can monitor Type0-PDCCH that schedules a PDSCH carrying an SIB1, and decode the SIB1. Since in the PBCH, a bandwidth of CORESET0 is set through a table, the maximum bandwidth of CORESET0 is implicitly defined in the protocol. Furthermore, the protocol specifies that a frequency domain resource of the PDSCH carrying the SIB1 is within the bandwidth (PRBs) of CORESET0, so the maximum bandwidth of the PDSCH carrying the SIB1 is also implicitly defined in the protocol. In fact, in an idle state, the UE works in initial active downlink bandwidth part (DL BWP). A frequency domain position of the initial active DL BWP is the same as a frequency domain position of CORESET0 by default (non-default, the frequency domain position of the initial active DL BWP can be modified through signaling to cover the frequency domain position of CORESET0), so the maximum bandwidth of the initial active DL BWP is implicitly defined in the protocol.

Network energy saving (or network power saving) has become a concern for operators and equipment manufacturers. Network energy saving is beneficial to reducing operating costs and promoting environmental protection. Since there are many spectrum resources in 5G networks, such as 1 GHz, 2 GHZ, 4 GHZ, 6 GHZ, 26 GHz, and other frequency bands, when a network load is low, carriers or cells corresponding to some frequency bands can be shut down as much as possible to achieve energy saving. In other words, when the network load is low, some carriers or cells do not need to carry data. However, currently, these carriers or cells still need to send periodic reference signals to support access and mobility of UEs. Therefore, how to achieve energy saving by optimizing a periodic reference signal on some carriers or cells has become an urgent problem to-be-solved.

The SSB can be used for a UE to achieve time-frequency synchronization and obtain an MIB and an SIB. For some carriers or cells, an SSB is only used for data load balancing, and the MIB and the SIB are no need, and therefore, the SSB (burst) can be simplified. Said carriers or cells can be called non-anchor carriers or cells. On the contrary, a few carriers or cells need to carry an MIB and an SIB to support cell search and system information transmission. Said carriers or cells can be called anchor carriers or cells. The non-anchor carriers or cells may still need to support paging, random access, and radio resource management (RRM) measurement, etc., and therefore, an SSB still needs to be carried to support auto gain control (AGC), time-frequency synchronization, and RRM measurement of the UE. However, the SSB can be simplified.

In order to achieve power saving, the simplified SSB can have a longer period, to reduce the number of transitions of the base station between sleep and SSB transmission and increase sleep time of the base station. It should be noted that, although a periodic reference signal on non-anchor carriers or cells can be simplified, beam sweeping still needs to be performed and a certain number of beams are required to meet coverage requirements. The following will describe some communication solutions provided in the disclosure to achieve network energy saving.

Solution 1: extend a period of a synchronization signal burst (or called “SS-burst period”). Within one period of a synchronization signal burst, N/synchronization signal bursts are sent. In the disclosure, the synchronization signal burst is equivalent to the synchronization signal block burst. The synchronization signal burst of the disclosure refers to one or more SSBs in a half frame. Generally, in a half frame, candidate positions of one or more SSBs are predefined.

N1 is an integer greater than 1. Extending the period of the synchronization signal burst may lead to an increase in power consumption of the UE, because the UE generally needs to process three synchronization signal bursts for AGC, time-frequency synchronization, and RRM measurement, but extending the SS-burst period will increase awake time of the UE (the UE needs to wake up within multiple SS-burst periods). In order to avoid increasing the awake time of the UE, one possible method is that the base station sends N1 (e.g., 3) synchronization signal bursts within one period of a synchronization signal burst. As such, the UE only needs to wake up within one period to process the N1 synchronization signal bursts for AGC, time-frequency synchronization, and RRM measurement.

N1 can be 3. The UE generally needs to process three synchronization signal bursts for AGC, time-frequency synchronization, and RRM measurement.

In an implementation, a period of the N1 synchronization signal bursts within one period of a synchronization signal burst is a first period, and the first period is less than the period of the synchronization signal burst. That is, within one period of a synchronization signal burst, the N1 synchronization signal bursts are sent by the base station in the first period. That is, within one period of a synchronization signal burst, the N1 synchronization signal bursts are received by the UE in the first period. That is, within one period of a synchronization signal burst, a period of the N1 synchronization signal bursts is the first period. The first period can be called a sub-period of the synchronization signal burst.

The first period is less than the period of the synchronization signal burst. That is, within one period of a synchronization signal burst, the N1 synchronization signal bursts are sent by the base station in the first period. That is, within one period of a synchronization signal burst, the N1 synchronization signal bursts are received by the UE in the first period. That is, within one period of a synchronization signal burst, a period of the N1 synchronization signal bursts is N1. In the disclosure, the period of the synchronization signal burst may be a period of an SSB, or a period of a half frame where an SSB is located, or a period of a half frame (a duration of the half frame is 5 milliseconds) for receiving an SSB, or a period of a half frame where a synchronization signal burst is located, or a period of a half frame for receiving a synchronization signal burst. In the disclosure, the period of the synchronization signal burst may be a period of an SSB configured by the base station, or a period of a half frame where an SSB is located (the period is configured by the base station), or a period of a half frame configured by the base station for receiving an SSB, or a period of a synchronization signal burst configured by the base station, or a period of a half frame where a synchronization signal burst is located (the period is configured by the base station), or a period of a half frame configured by the base station for receiving a synchronization signal burst. As an example, one period of a synchronization signal burst is 160 milliseconds. Within one period of a synchronization signal burst, three synchronization signal bursts are sent in a period of 5 milliseconds. The period of 5 milliseconds can be regarded as a sub-period of the synchronization signal burst, because the period of 5 milliseconds is much less than the period of the synchronization signal burst (160 milliseconds). As such, within one period of a synchronization signal burst and within 15 milliseconds, the base station can send three synchronization signal bursts. The first period is greater than or equal to 5 milliseconds. If the first period is less than 5 milliseconds, the design of the synchronization signal burst will need to be modified, which will increase complexity of the UE. In some implementations, the first period is at least 5 milliseconds, and a time domain position and a time index of an SSB in one synchronization signal burst are predefined within 5 milliseconds. If the sub-period of the synchronization signal burst is set to be less than 5 milliseconds, a time domain position and a time index of an SSB in one synchronization signal burst need to be redefined. The first period may be predefined or configured to 5 milliseconds. As such, the base station can complete sending of three synchronization signal bursts as soon as possible and enter a sleep state as soon as possible, so as to achieve network energy saving. Also, the UE can complete reception of the three synchronization signal bursts within one period of a synchronization signal burst to achieve energy saving for the UE. The first period may be predefined or configured to 10 milliseconds. As such, the base station can quickly complete sending of three synchronization signal bursts, and the UE can also complete reception of the three synchronization signal bursts within one period of a synchronization signal burst. In addition, the base station can flexibly choose to send the synchronization signal burst within the first 5 milliseconds of 10 milliseconds (first half frame) or the last 5 milliseconds of 10 milliseconds (second half frame), and place some signals/channels within 5 milliseconds when there is no synchronization signal burst, such as uplink transmission signals/channels, to reduce latency. The first period may also be predefined or configured to other durations, such as 15 milliseconds, 20 milliseconds, 25 milliseconds, 30 milliseconds, 40 milliseconds, etc., which is not limited in the disclosure.

Solution 2: extend a period of a synchronization signal burst. N2 synchronization signal bursts and N3 reference signal bursts are sent within one period of a synchronization signal burst.

A reference signal may be a PBCH DMRS or a tracking reference signal (TRS). N3 is an integer greater than 0, and N2 is 0 or an integer greater than 0.

Extending the period of the synchronization signal burst may lead to an increase in power consumption of the UE, because the UE generally needs to process three synchronization signal bursts for AGC, time-frequency synchronization, and RRM measurement, but extending the SS-burst period will increase awake time of the UE (the UE needs to wake up within multiple SS-burst periods). In order to avoid increasing the awake time of the UE, one possible method is that the base station sends, within one period of a synchronization signal burst, N2 synchronization signal bursts and N3 reference signal bursts. As such, the UE only needs to wake up within one period of a synchronization signal burst to process the N2 synchronization signal bursts and the N3 reference signal bursts for AGC, time-frequency synchronization, and RRM measurement.

N2 can be 0, 1, or 2. N2 can also be an integer greater than 2. N3 can be 3, 2, or 1. N3 can also be an integer greater than 3. In some implementations, the sum of N2 and N3 is 3. Generally, the UE needs to process three signal bursts including a synchronization signal burst(s) and a reference signal burst(s) (including at least one synchronization signal burst) for AGC, time-frequency synchronization, and RRM measurement. In some implementations, the sum of N2 and N3 is C, where C is a positive number greater than or equal to 1. C is configured by a higher layer parameter. This can bring flexibility to base station configuration. Generally, the UE needs to process C signal bursts including a synchronization signal burst(s) and a reference signal burst(s) (including at least one synchronization signal burst) for AGC, time-frequency synchronization, and RRM measurement.

In an implementation, a period of the N2 synchronization signal bursts within one period of a synchronization signal burst is a second period. That is, within one period of a synchronization signal burst, the N2 synchronization signal bursts are sent by the base station in the second period. That is, within one period of a synchronization signal burst, the N2 synchronization signal bursts are received by the UE in the second period. That is, within one period of a synchronization signal burst, a period of the N2 synchronization signal bursts is the second period. The second period can be called a sub-period of the synchronization signal burst.

The second period is less than the period of the synchronization signal burst. That is, within one period of a synchronization signal burst, the N2 synchronization signal bursts are sent by the base station in the second period. As an example, the period of the synchronization signal burst is 160 milliseconds. Within one period of a synchronization signal burst, two synchronization signal bursts are sent in a period of 5 milliseconds (i.e., the second period). The period of 5 milliseconds can be regarded as a sub-period of the synchronization signal burst, because the period of 5 milliseconds is much less than the period of the synchronization signal burst (160 milliseconds). As such, within one period of a synchronization signal burst and within 15 milliseconds, the base station can send three synchronization signal bursts. The second period may be greater than or equal to 5 milliseconds. If the second period is less than 5 milliseconds, the design of the synchronization signal burst will need to be modified, which will increase complexity of the UE. The second period is at least 5 milliseconds, and a time domain position and a time index of an SSB in one synchronization signal burst are predefined within 5 milliseconds. If the second period is set to be less than 5 milliseconds, a time domain position and a time index of an SSB in one synchronization signal burst need to be redefined. The second period may be predefined or configured to 5 milliseconds. As such, the base station can complete sending of three synchronization signal bursts as soon as possible and enter a sleep state as soon as possible, so as to achieve network energy saving. Also, the UE can complete reception of two synchronization signal bursts within one period of a synchronization signal burst, to achieve energy saving for the UE. The second period may be predefined or configured to 10 milliseconds. As such, the base station can quickly complete sending of two synchronization signal bursts, and the UE can also complete reception of the two synchronization signal bursts within one period of a synchronization signal burst, so as to achieve energy saving for the UE. In addition, the base station can flexibly choose to send the synchronization signal burst within the first 5 milliseconds of 10 milliseconds (first half frame) or the last 5 milliseconds of 10 milliseconds (second half frame), and place some signals/channels within 5 milliseconds when there is no synchronization signal burst, such as uplink transmission signals/channels, to reduce latency. The second period may also be predefined or configured to other durations, such as 15 milliseconds, 20 milliseconds, 25 milliseconds, 30 milliseconds, 40 milliseconds, etc., which is not limited in the disclosure.

Solution 2-1: within one period of a synchronization signal burst or one period of a reference signal burst, N3 reference signal bursts are sent in a third period. That is, within one period of a synchronization signal burst or one period of a reference signal burst, the N3 reference signal bursts are sent by the base station in the third period. That is, within one period of a synchronization signal burst or one period of a reference signal burst, the N3 reference signal bursts are received by the UE in the third period. That is, within one period of a synchronization signal burst or one period of a reference signal burst, a period of the N3 reference signal bursts is the third period. The third period can be called a sub-period of the reference signal burst. In the disclosure, a reference signal may be a TRS.

The third period is less than the period of the synchronization signal burst or the period of the reference signal burst. In the disclosure, the period of the reference signal burst may be a period of a reference signal burst configured by the base station, or a period of a half frame (5 milliseconds) where a reference signal burst is located (the period is configured by the base station), or a period of a time interval (e.g., x milliseconds) corresponding to a reference signal burst (the period is configured by the base station). That is, within one period of a synchronization signal burst, N3 reference signal bursts are sent by the base station in the second period. As an example, the period of the synchronization signal burst is 160 milliseconds. Within one period of a synchronization signal burst, two (N3=2) reference signal bursts are sent in a period of 5 milliseconds (i.e., the third period). The period of 5 milliseconds can be regarded as a sub-period of the reference signal burst, and the sub-period is much less than the period of the synchronization signal burst (160 milliseconds). As such, within one period of a synchronization signal burst and within 15 milliseconds, the base station can send three signal bursts including a synchronization signal burst(s) and a reference signal burst(s), such as one synchronization signal burst and two reference signal bursts. The third period may be greater than or equal to 5 milliseconds. In some implementations, the third period is at least 5 milliseconds. The period of the reference signal burst can be predefined to 5 milliseconds, and can correspond to the minimum period of the synchronization signal burst, and thus, resource overhead is minimized as much as possible while meeting synchronization requirements. The third period may be predefined or configured to 5 milliseconds. As such, the base station can complete sending of three signal bursts including a synchronization signal burst(s) and a reference signal burst(s) as soon as possible, and enter a sleep state as soon as possible, so as to achieve network energy saving. Also, the UE can complete reception of the three signal bursts within one period of a synchronization signal burst to achieve energy saving for the UE. The third period may be predefined or configured to 10 milliseconds. As such, the base station can quickly complete sending of three signal bursts including a synchronization signal burst(s) and a reference signal burst(s) (e.g., a TRS burst), and the UE can also complete reception of the three signal bursts within one period of a synchronization signal burst. In addition, a period of a TRS burst is at least 10 milliseconds currently. Since no decrease in the period of the TRS burst, no change is required to a system design, thereby avoiding an increase in complexity of the UE. The third period may also be predefined or configured to other durations, such as 15 milliseconds, 20 milliseconds, 25 milliseconds, 30 milliseconds, 40 milliseconds, etc., which is not limited in the disclosure.

Solution 2-2: the reference signal burst(s) is sent in the period of the synchronization signal burst (a long period), but an offset of the reference signal burst is different from an offset of the synchronization signal burst. Generally, an offset of a synchronization signal burst in a frame is 0 milliseconds (first half frame) or 5 milliseconds (second half frame) by default. As an example, the period of the synchronization signal burst is 160 milliseconds, and two reference signal bursts are also sent in a period of 160 milliseconds. However, offsets of the reference signal bursts are different from an offset of the synchronization signal burst. For instance, the offset of the synchronization signal burst is 0 milliseconds, an offset of the first reference signal burst is 5 milliseconds, and an offset of the second reference signal burst is 10 milliseconds. As such, within one period of a synchronization signal burst, the base station can send three signal bursts including a synchronization signal burst(s) and a reference signal burst(s), such as one synchronization signal burst and two reference signal bursts.

The reference signal burst(s) may be sent after the synchronization signal burst. The offset of the reference signal burst(s) may be greater than the offset of the synchronization signal burst. As such, the UE can first process certain symbols (e.g., PSS symbols) in the first synchronization signal burst to achieve AGC, and then perform time-frequency synchronization, so that the synchronization signal burst or the reference signal burst are not wasted. That is, by setting, with the base station, the offset of the reference signal burst or by predefining the offset of the reference signal burst, the reference signal burst can be sent after the synchronization signal burst. In other words, an index of a slot corresponding to the offset of the reference signal burst(s) is greater than an index of the last slot of the synchronization signal burst. For example, within one period of a synchronization signal burst, a synchronization signal burst(s) is sent in the first half frame of a first frame, and an index of the last slot occupied by the synchronization signal burst(s) is 3 (e.g., 8 synchronization signal blocks occupy 4 slots), a reference signal burst can follow the synchronization signal burst(s), and accordingly, an index of a slot corresponding to an offset of the reference signal burst can be 4, which is greater than 3. A gap between the serial number of the slot corresponding to the offset of the reference signal burst and the serial number of the last slot of the synchronization signal burst is greater than a preset value. Since the UE requires a certain time interval for time-frequency synchronization (the radio frequency, such as a phase-locked loop, needs to be adjusted after a time-frequency deviation is estimated, and it takes a certain time duration to stabilize after the radio frequency is adjusted, so that the time-frequency deviation can continue to be estimated), the UE processes the reference signal burst after elapse of a certain time interval from the synchronization signal burst. The preset value herein corresponds to UE processing capability. A time duration when the UE adjusts the radio frequency and waits for the radio frequency to stabilize depends on UE capability, and the time duration needs to be predefined, so that the base station and the UE can reach an agreement. The last slot of the synchronization signal burst may be the last slot containing a candidate SSB position. The candidate SSB position may be a predefined position of a candidate SSB in a half frame, or a position of a candidate SSB in a half frame for SSB sending, or a position where an SSB is sent potentially. If the last slot of the synchronization signal burst is the last slot containing a candidate SSB position, a position of the reference signal burst does not change with a position of an actual transmitted SSB, which can reduce complexity of the UE. The last slot of the synchronization signal burst can be the last slot containing a position of an actual transmitted SSB (“actual transmitted SSB position” in short). The actual transmitted SSB position is a position where the base station actually sends an SSB. For example, when there are a few beams for SSBs, the base station can only send a few SSBs. In this situation, the last slot containing the actual transmitted SSB position is earlier than the last slot containing the candidate SSB position, which can make the synchronization signal burst and the reference signal burst as close as possible, so that sending time of the base station can be reduced, thereby reducing power consumption. The last slot of the synchronization signal burst can be the last slot in a half frame where the synchronization signal burst is located. As such, a starting slot of a reference signal is relatively fixed, such as the first slot after a half frame.

Solution 3: extend a period of a reference signal burst (or called “reference signal burst period). Within one period of a reference signal burst, N4 reference signal bursts are sent.

A reference signal may be a PBCH DMRS or a TRS. In this situation, AGC, time-frequency synchronization, and RRM measurement do not rely on the synchronization signal burst, but only rely on the reference signal burst. N4 is an integer greater than 1.

Extending the period of the reference signal burst may lead to an increase in power consumption of the UE, because the UE generally needs to process three reference signal bursts for AGC, time-frequency synchronization, and RRM measurement, but extending the reference signal burst period will increase awake time of the UE (the UE needs to wake up within multiple reference signal burst periods). In order to avoid increasing the awake time of the UE, one possible method is that the base station sends, within one period of a reference signal burst, N4 (e.g., 3) reference signal bursts. As such, the UE only needs to wake up within one period of a reference signal burst to process the N4 reference signal bursts for AGC, time-frequency synchronization, and RRM measurement.

N4 can be 3. Generally, the UE needs to process three reference signal bursts for AGC, time-frequency synchronization, and RRM measurement.

In an implementation, a period of the N4 reference signal bursts within one period of a reference signal burst is a fourth period, and the fourth period is less than the period of the reference signal burst. That is, within one period of a synchronization signal burst or one period of a reference signal burst, the N4 reference signal bursts are sent by the base station in the fourth period. That is, within one period of a synchronization signal burst or one period of a reference signal burst, the N4 reference signal bursts are received by the UE in the fourth period. That is, within one period of a synchronization signal burst or one period of a reference signal burst, a period of the N4 reference signal bursts is the fourth period. The fourth period can be called a sub-period of the reference signal burst. In the disclosure, a reference signal may be a TRS.

The fourth period is less than the period of the reference signal burst. As an example, the period of the reference signal burst is 160 milliseconds. Within one period of a reference signal burst, three reference signal bursts are sent in a period of 5 milliseconds (i.e., the fourth period). The period of 5 milliseconds can be regarded as a sub-period of the reference signal burst, because the period of 5 milliseconds is much less than the period of the reference signal burst (160 milliseconds). As such, within one period of a reference signal burst and within 15 milliseconds, the base station can send three reference signal bursts. The fourth period may be greater than or equal to 5 milliseconds. If the fourth period is less than 5 milliseconds, the design of the reference signal burst (e.g., a PBCH DMRS burst) will need to be modified, which will increase complexity of the UE. In some implementations, the period of the reference signal burst (e.g., a PBCH DMRS burst) is at least 5 milliseconds, and a time domain position and a time index of a reference signal (e.g., a PBCH DMRS) in one reference signal burst are predefined within 5 milliseconds. If the sub-period of the reference signal burst (i.e., the fourth period) is set to be less than 5 milliseconds, a time domain position and a time index of a reference signal in one reference signal burst need to be redefined. The fourth period may be predefined or configured to 5 milliseconds. As such, the base station can complete sending of three reference signal bursts as soon as possible and enter a sleep state as soon as possible, so as to achieve network energy saving. Also, the UE can complete reception of the three reference signal bursts within one period of a synchronization signal burst, to achieve energy saving for the UE. The fourth period may be predefined or configured to 10 milliseconds. As such, the base station can quickly complete sending of three reference signal bursts, and the UE can complete reception of the three reference signal bursts within one period of a synchronization signal burst. In addition, the base station can flexibly choose to send the reference signal burst within the first 5 milliseconds of 10 milliseconds (first half frame) or the last 5 milliseconds of 10 milliseconds (second half frame), and place some signals/channels within 5 milliseconds when there is no reference signal burst, such as uplink transmission signals/channels, to reduce latency. The fourth period may also be predefined or configured to other durations, such as 15 milliseconds, 20 milliseconds, 25 milliseconds, 30 milliseconds, 40 milliseconds, etc., which is not limited in the disclosure.

In solution 1, solution 2 (solution 2-1 and solution 2-2), and solution 3, within one period of a synchronization signal burst, each reference signal in the reference signal burst and each synchronization signal in the synchronization signal burst have a quasi co-location (QCL) relationship. Specifically, within one period of a synchronization signal burst, each reference signal in the reference signal burst and each synchronization signal in the synchronization signal burst have at least one of the following relationships: a QCL type A (Type A), a QCL type B (Type B), a QCL Type C (Type C), or a QCL Type D (Type D). The QCL type A includes {Doppler shift, Doppler spread, average delay, delay spread}, the QCL type B includes {Doppler shift, Doppler spread}, the QCL type C includes {Doppler shift, average delay}, and the QCL type D includes {Spatial Rx parameter}.

Within one period of a synchronization signal burst, each reference signal in the reference signal burst has the same average receive power as each synchronization signal in the synchronization signal burst.

Solution 4: adopt a long-period window.

One possible method is that a synchronization measurement timing configuration (SMTC) period (e.g., 160 milliseconds) is extended through SMTC. The base station may send the synchronization signal burst(s) and/or the reference signal burst(s) only within the SMTC (corresponding to a first window). That is, the UE determines that the synchronization signal burst(s) and/or the reference signal burst(s) within the SMTC are valid. In other words, the UE determines that no synchronization signal burst and/or reference signal burst is outside the SMTC. Generally, the UE performs RRM measurement of a serving cell and a neighboring cell only within the SMTC, which can reduce RRM measurement activities of the UE. By adopting the above method, the base station can reduce sending of the synchronization signal burst and/or the reference signal burst by extending the SMTC period, thereby achieving energy saving for the base station.

The UE determining that the synchronization signal burst and/or the reference signal burst within the SMTC are valid can be understood as existence of the synchronization signal burst and/or the reference signal burst within the SMTC. Or, in other words, the synchronization signal burst and/or the reference signal burst are sent by the base station within the SMTC. Or, in other words, the UE determines that the synchronization signal burst and/or the reference signal burst are sent within the SMTC. Or, in other words, the synchronization signal burst and/or the reference signal burst can be received by the UE within the SMTC.

Another possible method is that a new window (i.e., the first window) is defined and a period of the new window is extended, for example, 160 milliseconds. The base station sends the synchronization signal burst(s) and/or the reference signal burst(s) only within the new window. That is, the UE determines that the synchronization signal burst(s) and/or the reference signal burst(s) within the first window are valid. In other words, the UE determines that no synchronization signal burst and/or reference signal burst is outside the first window. By adopting the above method, the base station can reduce sending of the synchronization signal burst and/or the reference signal burst by extending the period of the first window, thereby achieving energy saving for the base station. The period of the first window is configurable. The base station can reduce sending of the synchronization signal burst and/or the reference signal burst by configuring the period of the first window. The period of the first window is an extended period of the synchronization signal burst and/or the reference signal burst, and their own short period (within the first window) of the synchronization signal burst and/or the reference signal burst is a sub-period. An offset of the first window is configurable. The base station can adjust sending occasion of the synchronization signal burst and/or the reference signal burst by configuring the offset of the first window, which can avoid resource conflicts and achieve flexible network configuration. A window length of the first window is configurable. The window length can also be called duration. The base station can control the number of synchronization signal bursts and/or reference signal bursts sent in one period by configuring the window length of the first window. By configuring the period, the offset, and the window length of the first window, sending of the synchronization signal burst(s) and/or the reference signal burst(s) can be configured.

The first window may be SMTC. Generally, the UE performs RRM measurement of a serving cell and a neighboring cell only within the SMTC, which can reduce RRM measurement activities of the UE.

The communication solutions provided in the disclosure for achieving network energy saving have been introduced in the previous text. The communication solutions provided in the disclosure will be described below from the perspectives of a UE side and a base station side with reference to the accompanying drawings.

FIG. 2 is a flowchart illustrating a communication method provided in implementations of the disclosure. As illustrated in FIG. 2, the communication method includes the following.

201, a UE receives, within one period of a synchronization signal burst, N1 synchronization signal bursts, where N1 is an integer greater than 1.

It should be understood that, corresponding to the operations at 201 performed by the UE, a base station performs the following operations: within one period of the synchronization signal burst, sending the N1 synchronization signal bursts to the UE.

In an implementation, a period of the N1 synchronization signal bursts within one period of the synchronization signal burst is a first period, and the first period is less than the period of the synchronization signal burst. It should be understood that, the N1 synchronization signal bursts are sent by the base station in the first period.

In an implementation, the first period is greater than or equal to 5 milliseconds.

In an implementation, the first period is greater than or equal to 10 milliseconds.

In an implementation, the communication method further includes: performing time-frequency synchronization with the N1 synchronization signal bursts. Optionally, N1 is 3 or an integer greater than 3.

In an implementation, the communication method further includes: receiving first configuration information, where the first configuration information is used for configuring the UE to receive the N1 synchronization signal bursts within one period of the synchronization signal burst. For example, a device at base station side sends the first configuration information to the UE through higher layer signaling, and the UE receives the synchronization signal bursts according to the first configuration information.

In implementations of the disclosure, the UE receives N1 synchronization signal bursts within one period of a synchronization signal burst. As such, the UE only needs to wake up within one period to process the N1 synchronization signal bursts for time-frequency synchronization, thereby reducing power consumption.

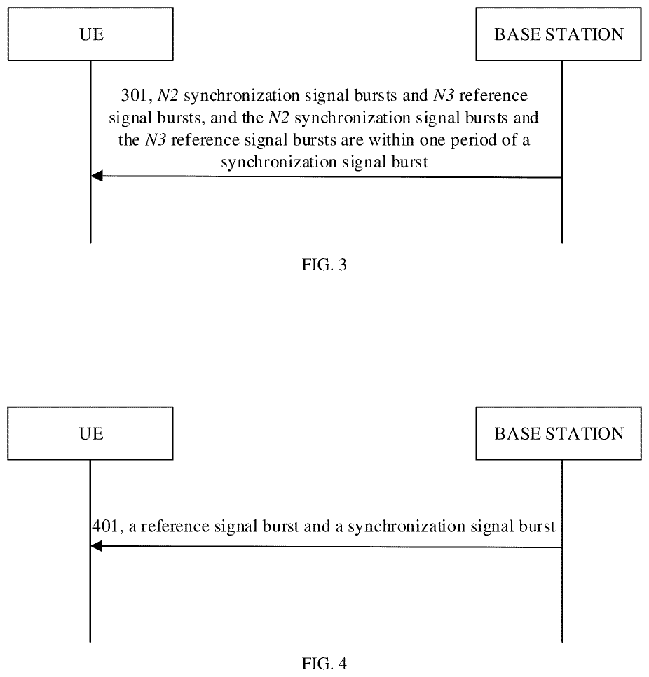

FIG. 3 is a flowchart illustrating a communication method provided in other implementations of the disclosure. As illustrated in FIG. 3, the communication method includes the following.

301, a UE receives, within one period of a synchronization signal burst, N2 synchronization signal bursts and N3 reference signal bursts, where N2 is an integer greater than or equal to 0, and N3 is an integer greater than 0.

It should be understood that, corresponding to the operations at 301 performed by the UE, a base station performs the following operations: within one period of the synchronization signal burst, sending the N2 synchronization signal bursts and the N3 reference signal bursts to the UE.

In an implementation, the sum of N2 and N3 is an integer greater than 1.

In an implementation, the sum of N2 and N3 is 3, and N3 is 3, 2, or 1.

In an implementation, a period of the N2 synchronization signal bursts within one period of the synchronization signal burst is a second period, and the second period is less than the period of the synchronization signal burst.

In an implementation, the second period is greater than or equal to 5 milliseconds.

In an implementation, the second period is greater than or equal to 10 milliseconds.

In an implementation, a period of the N3 reference signal bursts within one period of the synchronization signal burst is a third period, and the third period is less than the period of the synchronization signal burst.

In an implementation, the third period is greater than or equal to 5 milliseconds.

In an implementation, the third period is greater than or equal to 10 milliseconds.

In an implementation, a period of the N3 reference signal bursts is a period of the synchronization signal bursts.

In an implementation, the N3 reference signal bursts are located after the N2 synchronization signal bursts. It should be understood that, the base station first sends the N2 synchronization signal bursts, and then sends the N3 reference signal bursts. That is, the UE first receives the N2 synchronization signal bursts, and then receives the N3 reference signal bursts.

In an implementation, indexes of slots corresponding to the N3 reference signal bursts are greater than an index of the last slot of the N2 synchronization signal bursts. The last slot of the synchronization signal bursts represents the last slot for synchronization signal burst transmission, or the last slot in a half frame where synchronization signal burst transmission occurs, or the last slot in a half frame for synchronization signal burst transmission.

In an implementation, offsets of the N3 reference signal bursts satisfy: indexes of slots corresponding to the N3 reference signal bursts being greater than an index of the last slot of the N2 synchronization signal bursts.

In an implementation, gaps between indexes of slots corresponding to the N3 reference signal bursts and an index of the last slot of the N2 synchronization signal bursts are greater than a first gap. The first gap may be set in advance. The first gap may also be configured by the base station. The first gap may be configured by the base station according to UE capability. For a UE with weak capability, the first gap is relatively large, because the UE with weak capability may not have enough time to handle the reference signal burst if the reference signal burst is too close to the synchronization signal burst. For a UE with strong capability, the first gap is relatively small.

In an implementation, offsets of the N3 reference signal bursts satisfy: gaps between indexes of slots corresponding to the N3 reference signal bursts and an index of the last slot of the N2 synchronization signal bursts being greater than a first gap.

In an implementation, the first gap corresponds to UE capability.

In an implementation, the last slot of the N2 synchronization signal bursts is the last slot containing a candidate SSB position.

In an implementation, the last slot of the N2 synchronization signal bursts is the last slot containing a position of an actual transmitted SSB.

In an implementation, the last slot of the N2 synchronization signal bursts is the last slot in a half frame where the synchronization signal burst is located.

In an implementation, the N3 reference signal bursts include one or two of a PBCH DMRS and a TRS.

In an implementation, the communication method further includes: performing AGC and time-frequency synchronization with the N2 synchronization signal bursts, and/or performing RRM measurement with the N3 reference signal bursts.

In an implementation, the communication method further includes: receiving second configuration information, where the second configuration information is used for configuring the UE to receive the N2 synchronization signal bursts and the N3 reference signal bursts within one period of the synchronization signal burst. For example, a device at base station side sends the second configuration information to the UE through higher layer signaling, and the UE receives the synchronization signal bursts and the reference signal bursts according to the second configuration information.

In implementations of the disclosure, the UE receives N2 synchronization signal bursts and N3 reference signal bursts within one period of a synchronization signal burst. As such, the UE only needs to wake up within one period to process the N2 synchronization signal bursts and the N3 reference signal bursts for AGC, time-frequency synchronization, and RRM measurement, thereby reducing power consumption.

FIG. 4 is a flowchart illustrating a communication method provided in other implementations of the disclosure. As illustrated in FIG. 4, the communication method includes the following.

401, a UE receives a reference signal burst(s) and a synchronization signal burst(s), where a period of the reference signal burst(s) is equal to a period of the synchronization signal burst(s).

It should be understood that, corresponding to the operations at 401 performed by the UE, a base station performs the following operations: sending the reference signal burst(s) and the synchronization signal burst(s). In some implementations, in the period of the reference signal burst (or the period of the synchronization signal burst), the base station sends the reference signal burst(s) and the synchronization signal burst(s). That is, the period of the reference signal burst and the period of the synchronization signal burst coincide in time.

In an implementation, an offset of the reference signal burst is not equal to an offset of the synchronization signal burst.

In an implementation, an index of a slot corresponding to the reference signal burst is greater than an index of the last slot of the synchronization signal burst.

In an implementation, an offset of the reference signal burst satisfies: an index of a slot corresponding to the reference signal burst being greater than an index of the last slot of the synchronization signal burst.

In an implementation, a gap between an index of a slot corresponding to the reference signal burst and an index of the last slot of the synchronization signal burst is greater than a first gap.

In an implementation, an offset of the reference signal burst satisfies: a gap between an index of a slot corresponding to the reference signal burst and an index of the last slot of the synchronization signal burst being greater than a first gap.

In an implementation, the first gap corresponds to UE capability.

In an implementation, the last slot of the synchronization signal burst is the last slot containing a candidate SSB position.

In an implementation, the last slot of the synchronization signal burst is the last slot containing a position of an actual transmitted SSB.

In an implementation, the last slot of the synchronization signal burst is the last slot in a half frame where the synchronization signal burst is located.

In an implementation, the reference signal burst includes one or two of a PBCH DMRS and a TRS.

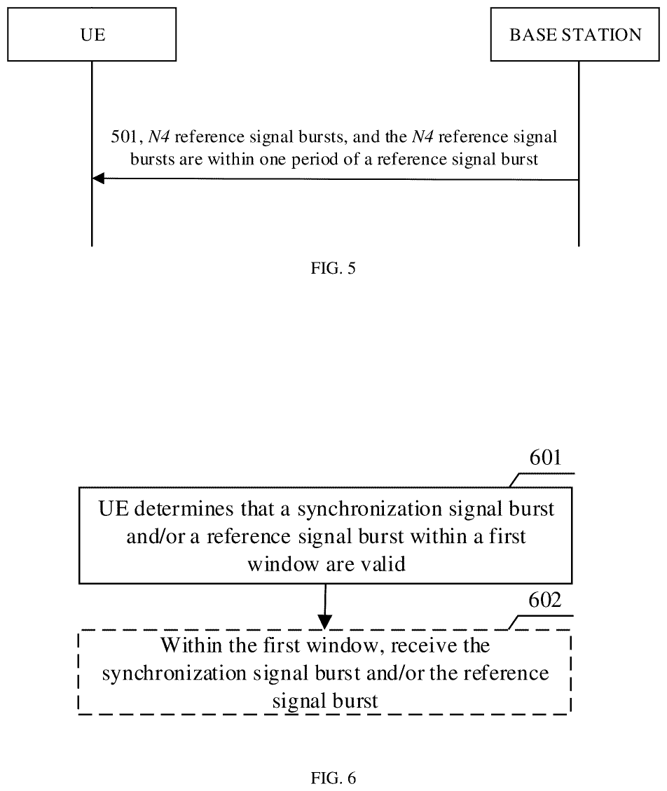

FIG. 5 is a flowchart illustrating a communication method provided in other implementations of the disclosure. As illustrated in FIG. 5, the communication method includes the following.

501, a UE receives, within one period of a reference signal burst, N4 reference signal bursts, where N4 is an integer greater than 1.

It should be understood that, corresponding to the operations at 501 performed by the UE, a base station performs the following operations: within one period of the reference signal burst, sending the N4 reference signal bursts to the UE.

In an implementation, a period of the N4 reference signal bursts within one period of the reference signal burst is a fourth period, and the fourth period is less than the period of the reference signal burst.

In an implementation, the fourth period is greater than or equal to 5 milliseconds.

In an implementation, the fourth period is greater than or equal to 10 milliseconds.

In an implementation, the N4 reference signal bursts include one or two of a PBCH DMRS and a TRS.

In an implementation, the communication method further includes: performing RRM measurement with the N4 reference signal bursts.

In an implementation, the communication method further includes: receiving third configuration information, where the third configuration information is used for configuring the UE to receive the N4 reference signal bursts within one period of the reference signal burst. For example, a device at base station side sends the third configuration information to the UE through higher layer signaling, and the UE receives the reference signal bursts according to the third configuration information.

In implementations of the disclosure, the UE receives N4 reference signal bursts within one period of a reference signal burst. As such, the UE only needs to wake up within one period to process the N4 reference signal bursts for RRM measurement, thereby reducing power consumption.

FIG. 6 is a flowchart illustrating a communication method provided in other implementations of the disclosure. As illustrated in FIG. 6, the communication method includes the following.

601, a UE determines that a synchronization signal burst(s) and/or a reference signal burst(s) within a first window are valid.

It should be understood that, corresponding to the operations at 501 performed by the UE, a base station performs the following operations: within the first window, sending the synchronization signal burst(s) and/or the reference signal burst(s). Or, in other words, the UE determines that the synchronization signal burst and/or the reference signal burst are sent by the base station within the first window.

The UE determining that the synchronization signal burst and/or the reference signal burst within the first window are valid can be understood as presence of the synchronization signal (block) burst and/or the reference signal burst within the first window. Or, in other words, the synchronization signal (block) burst and/or the reference signal burst are sent by the base station within the first window. Or, in other words, the UE determines that the synchronization signal (block) burst and/or the reference signal burst are sent within the first window. Or, in other words, the synchronization signal (block) burst and/or the reference signal burst can be received by the UE within the first window. In an implementation, the first window corresponds to SMTC. As an example, the UE uses SMTC to extend an SMTC period, such as 160 milliseconds. The base station sends the synchronization signal burst and/or the reference signal burst only within the SMTC. As another example, the UE defines a new window (i.e. a first window) and extends a period of the new window, such as 160 milliseconds. The base station sends the synchronization signal burst and/or the reference signal burst only within the new window.

In an implementation, one or more of a period, an offset, and a window length of the first window are configurable.

In an implementation, determining that the synchronization signal burst and/or the reference signal burst within the first window are valid includes: determining to receive N1 synchronization signal bursts within the first window, where N1 is an integer greater than 1. For example, the first window is one period of a synchronization signal burst, within the first window, N1 synchronization signal bursts can be received.

In an implementation, determining that the synchronization signal burst and/or the reference signal burst within the first window are valid includes: determining to receive N2 synchronization signal bursts and N3 reference signal bursts within the first window, where N2 is an integer greater than or equal to 0, and N3 is an integer greater than 0. For example, the first window is one period of a synchronization signal burst, within the first window, N2 synchronization signal bursts and N3 reference signal bursts can be received.

In an implementation, determining that the synchronization signal burst and/or the reference signal burst within the first window are valid includes: determining to receive N4 reference signal bursts within the first window, where N4 is an integer greater than 1. For example, the first window is one period of a reference signal burst, within the first window, N4 reference signal bursts can be received.

In an implementation, the communication method further includes: receiving first configuration information. Determining that the synchronization signal burst and/or the reference signal burst within the first window are valid includes: determining to receive N1 synchronization signal bursts within the first window according to the first configuration information, where N1 is an integer greater than 1.

In an implementation, the communication method further includes: receiving second configuration information. Determining that the synchronization signal burst and/or the reference signal burst within the first window are valid includes: determining to receive N2 synchronization signal bursts and N3 reference signal bursts within the first window according to the second configuration information, where N2 is an integer greater than or equal to 0, and N3 is an integer greater than 0.

In an implementation, the communication method further includes: receiving third configuration information. Determining that the synchronization signal burst and/or the reference signal burst within the first window are valid includes: determining to receive N4 reference signal bursts within the first window according to the third configuration information, where N4 is an integer greater than 1.

In some implementations, the UE also performs the following operations: 602, within the first window, receiving the synchronization signal burst(s) and/or the reference signal burst(s).

In implementations of the disclosure, the UE determines that a synchronization signal burst and/or a reference signal burst within a first window are valid, and only needs to receive the synchronization signal burst and/or the reference signal burst within the first window. As such, the UE does not need to receive the synchronization signal burst and/or the reference signal burst outside the first window, thereby reducing power consumption.

The following will introduce the communication apparatus provided in implementations of the disclosure.

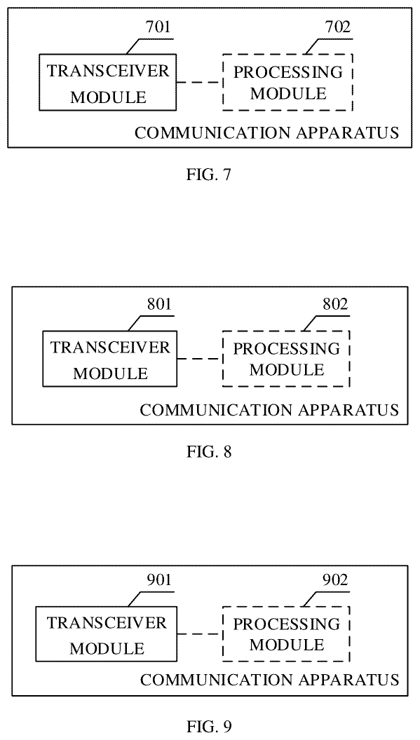

FIG. 7 is a schematic structural diagram illustrating a communication apparatus provided in implementations of the disclosure. The communication apparatus can be configured to perform the operations performed by the UE in the foregoing method implementations. For example, the communication apparatus can be configured to execute the method executed by the UE illustrated in FIG. 2. As illustrated in FIG. 7, the communication apparatus includes a transceiver module 701, the transceiver module 701 is configured to receive, within one period of a synchronization signal burst, N1 synchronization signal bursts, where N1 is an integer greater than 1.

In an implementation, a period of the N1 synchronization signal bursts within one period of the synchronization signal burst is a first period, and the first period is less than the period of the synchronization signal burst.

In an implementation, the first period is greater than or equal to 5 milliseconds.

In an implementation, the first period is greater than or equal to 10 milliseconds.

In an implementation, the communication apparatus in FIG. 7 further includes a processing module 702, the processing module 702 is configured to perform time-frequency synchronization with the N1 synchronization signal bursts.

In an implementation, the transceiver module 701 is further configured to receive first configuration information, where the first configuration information is used for configuring the UE to receive the N1 synchronization signal bursts within one period of the synchronization signal burst.

FIG. 8 is a schematic structural diagram illustrating a communication apparatus provided in other implementations of the disclosure. The communication apparatus can be configured to perform the operations performed by the UE in the foregoing method implementations. For example, the communication apparatus can be configured to execute the method executed by the UE illustrated in FIG. 3. As illustrated in FIG. 8, the communication apparatus includes a transceiver module 801, the transceiver module 801 is configured to receive, within one period of a synchronization signal burst, N2 synchronization signal bursts and N3 reference signal bursts, where N2 is an integer greater than or equal to 0, and N3 is an integer greater than 0.

In an implementation, the sum of N2 and N3 is an integer greater than 1.

In an implementation, the sum of N2 and N3 is 3, and N3 is 3, 2, or 1.

In an implementation, a period of the N2 synchronization signal bursts within one period of the synchronization signal burst is a second period, and the second period is less than the period of the synchronization signal burst.

In an implementation, the second period is greater than or equal to 5 milliseconds.

In an implementation, the second period is greater than or equal to 10 milliseconds.

In an implementation, a period of the N3 reference signal bursts within one period of the synchronization signal burst is a third period, and the third period is less than the period of the synchronization signal burst.

In an implementation, the third period is greater than or equal to 5 milliseconds.

In an implementation, the third period is greater than or equal to 10 milliseconds.

In an implementation, a period of the N3 reference signal bursts is a period of the synchronization signal bursts.

In an implementation, the N3 reference signal bursts are located after the N2 synchronization signal bursts.

In an implementation, indexes of slots corresponding to the N3 reference signal bursts are greater than an index of the last slot of the N2 synchronization signal bursts.

In an implementation, offsets of the N3 reference signal bursts satisfy: indexes of slots corresponding to the N3 reference signal bursts being greater than an index of the last slot of the N2 synchronization signal bursts.

In an implementation, gaps between indexes of slots corresponding to the N3 reference signal bursts and an index of the last slot of the N2 synchronization signal bursts are greater than a first gap.

In an implementation, offsets of the N3 reference signal bursts satisfy: gaps between indexes of slots corresponding to the N3 reference signal bursts and an index of the last slot of the N2 synchronization signal bursts being greater than a first gap.

In an implementation, the first gap corresponds to UE capability.

In an implementation, the last slot of the N2 synchronization signal bursts is the last slot containing a candidate SSB position.

In an implementation, the last slot of the N2 synchronization signal bursts is the last slot containing a position of an actual transmitted SSB.

In an implementation, the last slot of the N2 synchronization signal bursts is the last slot in a half frame where the synchronization signal burst is located.

In an implementation, the N3 reference signal bursts include one or two of a PBCH DMRS and a TRS.

In an implementation, the communication apparatus in FIG. 8 further includes a processing module 802, the processing module 802 is configured to perform AGC and time-frequency synchronization with the N2 synchronization signal bursts, and/or perform RRM measurement with the N3 reference signal bursts.

In an implementation, the transceiver module 801 is further configured to receive second configuration information, where the second configuration information is used for configuring the UE to receive the N2 synchronization signal bursts and the N3 reference signal bursts within one period of the synchronization signal burst.

FIG. 9 is a schematic structural diagram illustrating a communication apparatus provided in other implementations of the disclosure. The communication apparatus can be configured to perform the operations performed by the UE in the foregoing method implementations. For example, the communication apparatus can be configured to execute the method executed by the UE illustrated in FIG. 4. As illustrated in FIG. 9, the communication apparatus includes a transceiver module 901, the transceiver module 901 is configured to receive a reference signal burst and a synchronization signal burst, where a period of the reference signal burst is equal to a period of the synchronization signal burst.

In an implementation, the communication apparatus in FIG. 9 further includes a processing module 902, the processing module 902 is configured for RRM measurement.

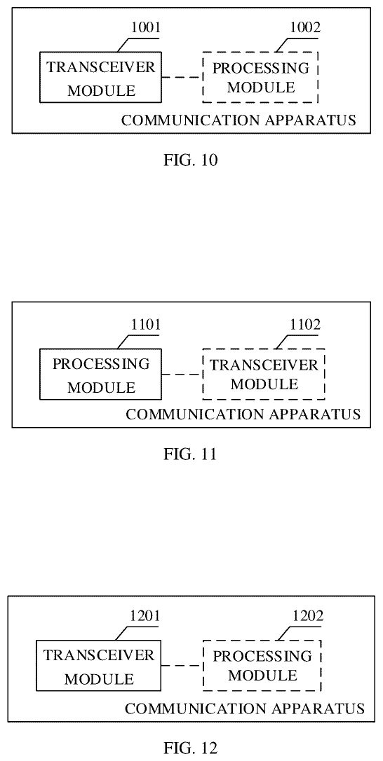

FIG. 10 is a schematic structural diagram illustrating a communication apparatus provided in other implementations of the disclosure. The communication apparatus can be configured to perform the operations performed by the UE in the foregoing method implementations. For example, the communication apparatus can be configured to execute the method executed by the UE illustrated in FIG. 5. As illustrated in FIG. 10, the communication apparatus includes a transceiver module 1001, the transceiver module 1001 is configured to receive, within one period of a reference signal burst, N4 reference signal bursts, where N4 is an integer greater than 1.

In an implementation, a period of the N4 reference signal bursts within one period of the reference signal burst is a fourth period, and the fourth period is less than the period of the reference signal burst.

In an implementation, the fourth period is greater than or equal to 5 milliseconds.

In an implementation, the fourth period is greater than or equal to 10 milliseconds.

In an implementation, the N4 reference signal bursts include one or two of a PBCH DMRS and a TRS.

In an implementation, the communication apparatus in FIG. 10 further includes a processing module 1002, the processing module 1002 is configured to perform RRM measurement with the N4 reference signal bursts.

In an implementation, the transceiver module 1001 is further configured to receive third configuration information, where the third configuration information is used for configuring the UE to receive the N4 reference signal bursts within one period of the reference signal burst.

FIG. 11 is a schematic structural diagram illustrating a communication apparatus provided in other implementations of the disclosure. The communication apparatus can be configured to perform the operations performed by the UE in the foregoing method implementations. For example, the communication apparatus can be configured to execute the method executed by the UE illustrated in FIG. 6. As illustrated in FIG. 11, the communication apparatus includes a processing module 1101, the processing module 1101 is configured to determine that a synchronization signal burst and/or a reference signal burst within a first window are valid.

In an implementation, the first window corresponds to SMTC.

In an implementation, one or more of a period, an offset, and a window length of the first window are configurable.

In an implementation, the processing module 1101 is specifically configured to determine to receive N1 synchronization signal bursts within the first window, where N1 is an integer greater than 1.

In an implementation, the processing module 1101 is specifically configured to determine to receive N2 synchronization signal bursts and N3 reference signal bursts within the first window, where N2 is an integer greater than or equal to 0, and N3 is an integer greater than 0. For example, the first window is one period of a synchronization signal burst, within the first window, N2 synchronization signal bursts and N3 reference signal bursts can be received.

In an implementation, the processing module 1101 is specifically configured to determine to receive N4 reference signal bursts within the first window, where N4 is an integer greater than 1.

In an implementation, the communication apparatus further includes a transceiver module 1102, the transceiver module 1102 is configured to receive first configuration information. The processing module 1101 configured to determine that the synchronization signal burst and/or the reference signal burst within the first window are valid is specifically configured to determine to receive N1 synchronization signal bursts within the first window according to the first configuration information, where N1 is an integer greater than 1.

In an implementation, the transceiver module 1102 is further configured to receive second configuration information. The processing module 1101 configured to determine that the synchronization signal burst and/or the reference signal burst within the first window are valid is specifically configured to determine to receive N2 synchronization signal bursts and N3 reference signal bursts within the first window according to the second configuration information, where N2 is an integer greater than or equal to 0, and N3 is an integer greater than 0.

In an implementation, the transceiver module 1102 is further configured to receive third configuration information. The processing module 1101 configured to determine that the synchronization signal burst and/or the reference signal burst within the first window are valid is specifically configured to determine to receive N4 reference signal bursts within the first window according to the third configuration information, where N4 is an integer greater than 1.

FIG. 12 is a schematic structural diagram illustrating a communication apparatus provided in implementations of the disclosure. The communication apparatus can be configured to perform the operations performed by the base station in the foregoing method implementations. For example, the communication apparatus can be configured to execute the method executed by the base station illustrated in FIG. 2. As illustrated in FIG. 12, the communication apparatus includes a transceiver module 1201, the transceiver module 1201 is configured to send, within one period of a synchronization signal burst, N1 synchronization signal bursts, N1 being an integer greater than 1.

In an implementation, a period of the N1 synchronization signal bursts within one period of the synchronization signal burst is a first period, and the first period is less than the period of the synchronization signal burst.

In an implementation, the first period is greater than or equal to 5 milliseconds.

In an implementation, the first period is greater than or equal to 10 milliseconds.

In an implementation, the transceiver module 1201 is further configured to send first configuration information, where the first configuration information is used for configuring the UE to receive the N1 synchronization signal bursts within one period of the synchronization signal burst.

In an implementation, the communication apparatus further includes a processing module 1202, the processing module 1202 is configured to generate the N1 synchronization signal bursts. In some implementations, the processing module 1202 is configured to generate the N1 synchronization signal bursts and control the transceiver module 1201 to send the N1 synchronization signal bursts within one period of the synchronization signal burst.

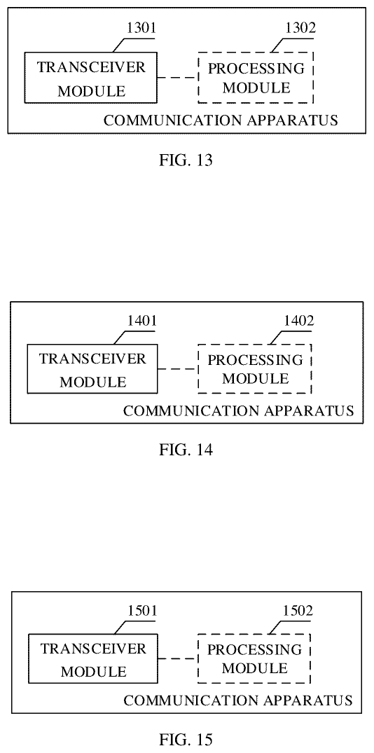

FIG. 13 is a schematic structural diagram illustrating a communication apparatus provided in other implementations of the disclosure. The communication apparatus can be configured to perform the operations performed by the base station in the foregoing method implementations. For example, the communication apparatus can be configured to execute the method executed by the base station illustrated in FIG. 3. As illustrated in FIG. 13, the communication apparatus includes a transceiver module 1301, the transceiver module 1301 is configured to send, within one period of a synchronization signal burst, N2 synchronization signal bursts and N3 reference signal bursts, where N2 is an integer greater than or equal to 0, and N3 is an integer greater than 0.

In an implementation, the sum of N2 and N3 is an integer greater than 1.

In an implementation, the sum of N2 and N3 is 3, and N3 is 3, 2, or 1.

In an implementation, a period of the N2 synchronization signal bursts within one period of the synchronization signal burst is a second period, and the second period is less than the period of the synchronization signal burst.

In an implementation, the second period is greater than or equal to 5 milliseconds.

In an implementation, the second period is greater than or equal to 10 milliseconds.

In an implementation, a period of the N3 reference signal bursts is a period of the synchronization signal bursts.

In an implementation, the N3 reference signal bursts are located after the N2 synchronization signal bursts.

In an implementation, indexes of slots corresponding to the N3 reference signal bursts are greater than an index of the last slot of the N2 synchronization signal bursts.

In an implementation, offsets of the N3 reference signal bursts satisfy: indexes of slots corresponding to the N3 reference signal bursts being greater than an index of the last slot of the N2 synchronization signal bursts.

In an implementation, gaps between indexes of slots corresponding to the N3 reference signal bursts and an index of the last slot of the N2 synchronization signal bursts are greater than a first gap.

In an implementation, offsets of the N3 reference signal bursts satisfy: gaps between indexes of slots corresponding to the N3 reference signal bursts and an index of the last slot of the N2 synchronization signal bursts being greater than a first gap.

In an implementation, the first gap corresponds to UE capability.

In an implementation, the last slot of the N2 synchronization signal bursts is the last slot containing a candidate SSB position.

In an implementation, the last slot of the N2 synchronization signal bursts is the last slot containing a position of an actual transmitted SSB.

In an implementation, the last slot of the N2 synchronization signal bursts is the last slot in a half frame where the synchronization signal burst is located.

In an implementation, the N3 reference signal bursts include one or two of a PBCH DMRS and a TRS.

In an implementation, the transceiver module 1301 is further configured to send second configuration information, where the second configuration information is used for configuring the UE to receive the N2 synchronization signal bursts and the N3 reference signal bursts within one period of the synchronization signal burst.

In an implementation, the communication apparatus further includes a processing module 1302, the processing module 1302 is configured to generate the N2 synchronization signal bursts and the N3 reference signal bursts. In some implementations, the processing module 1302 is configured to generate the N2 synchronization signal bursts and the N3 reference signal bursts, and control the transceiver module 1301 to send the N2 synchronization signal bursts and the N3 reference signal bursts within one period of the synchronization signal burst.

FIG. 14 is a schematic structural diagram illustrating a communication apparatus provided in other implementations of the disclosure. The communication apparatus can be configured to perform the operations performed by the base station in the foregoing method implementations. For example, the communication apparatus can be configured to execute the method executed by the base station illustrated in FIG. 4. As illustrated in FIG. 14, the communication apparatus includes a transceiver module 1401, the transceiver module 1401 is configured to send a reference signal burst and a synchronization signal burst, where a period of the reference signal burst is equal to a period of the synchronization signal burst.

In an implementation, the communication apparatus in FIG. 14 further includes a processing module 1402, the processing module 1402 is configured to generate the reference signal burst and the synchronization signal burst.

FIG. 15 is a schematic structural diagram illustrating a communication apparatus provided in other implementations of the disclosure. The communication apparatus can be configured to perform the operations performed by the base station in the foregoing method implementations. For example, the communication apparatus can be configured to execute the method executed by the base station illustrated in FIG. 5. As illustrated in FIG. 15, the communication apparatus includes a transceiver module 1501, the transceiver module 1501 is configured to send, within one period of a reference signal burst, N4 reference signal bursts, where N4 is an integer greater than 1.

In an implementation, a period of the N4 reference signal bursts within one period of the reference signal burst is a fourth period, and the fourth period is less than the period of the reference signal burst.

In an implementation, the fourth period is greater than or equal to 5 milliseconds.

In an implementation, the fourth period is greater than or equal to 10 milliseconds.

In an implementation, the N4 reference signal bursts include one or two of a PBCH DMRS and a TRS.

In an implementation, the transceiver module 1501 is further configured to send third configuration information, where the third configuration information is used for configuring the UE to receive the N4 reference signal bursts within one period of the reference signal burst.

In an implementation, the communication apparatus further includes a processing module 1502, the processing module 1502 is configured to generate the N4 reference signal bursts. In some implementations, the processing module 1502 is configured to generate the N4 reference signal bursts and control the transceiver module 1501 to send the N4 reference signal bursts within one period of the reference signal burst.

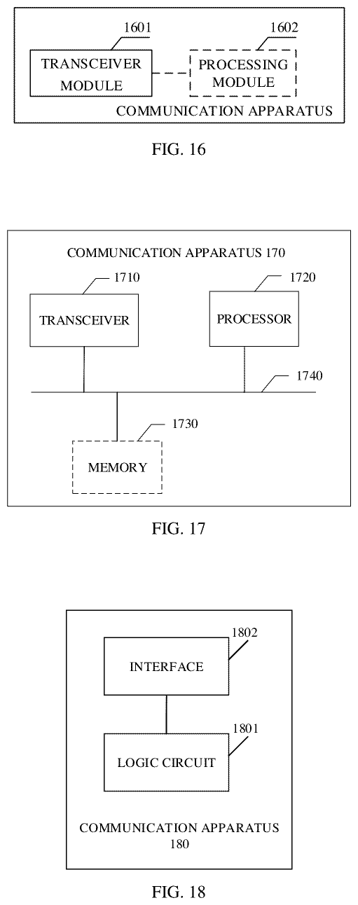

FIG. 16 is a schematic structural diagram illustrating a communication apparatus provided in other implementations of the disclosure. The communication apparatus can be configured to perform the operations performed by the base station in the foregoing method implementations. As illustrated in FIG. 16, the communication apparatus includes a transceiver module 1601, the transceiver module 1601 is configured to send, within a first window, a synchronization signal burst and/or a reference signal burst.

In an implementation, the first window corresponds to SMTC.

In an implementation, one or more of a period, an offset, and a window length of the first window are configurable.

In an implementation, the transceiver module 1601 is specifically configured to send N1 synchronization signal bursts within the first window, where N1 is an integer greater than 1.

In an implementation, the transceiver module 1601 is specifically configured to send N2 synchronization signal bursts and N3 reference signal bursts within the first window, where N2 is an integer greater than or equal to 0, and N3 is an integer greater than 0.

In an implementation, the transceiver module 1601 is specifically configured to send N4 reference signal bursts within the first window, where N4 is an integer greater than 1.

In an implementation, the transceiver module 1601 is further configured to send first configuration information, where the first configuration information is used for configuring the UE to receive the N1 synchronization signal bursts within the first window.

In an implementation, the transceiver module 1601 is further configured to send second configuration information, where the second configuration information is used for configuring the UE to receive the N2 synchronization signal bursts and the N3 reference signal bursts within the first window.

In an implementation, the transceiver module 1601 is further configured to send third configuration information, where the third configuration information is used for configuring the UE to receive the N4 reference signal bursts within the first window.

In an implementation, the communication apparatus further includes a processing module 1602, the processing module 1602 is configured to generate the synchronization signal burst and/or the reference signal burst. In some implementations, the processing module 1602 is configured to generate the synchronization signal burst and/or the reference signal burst, and control the transceiver module 1601 to send the synchronization signal burst and/or the reference signal burst within the first window.

FIG. 17 is a schematic structural diagram illustrating a communication apparatus 170 provided in other implementations of the disclosure. The communication apparatus in FIG. 17 can be the above UE. The communication apparatus in FIG. 17 can be the above base station.

As illustrated in FIG. 17, the communication apparatus 170 includes at least one processor 1720 and at least one transceiver 1710.

In some implementations of the disclosure, the processor 1720 and the transceiver 1710 can be configured to implement the functions or operations performed by the above UE. The transceiver 1710 is configured to perform one or more of the operations at 201 in FIG. 2, the operations at 301 in FIG. 3, the operations at 401 in FIG. 4, and the operations at 502 in FIG. 5. The processor 1720 is configured to perform the operations at 501 in FIG. 5.

In other implementations of the disclosure, the processor 1720 and the transceiver 1710 can be configured to implement the functions or operations performed by the above base station.

The transceiver 1710 is configured to communicate with other devices/apparatuses through transmission media. The processor 1720 sends and receives data and/or signalling with the transceiver 1710, and is configured to implement the method in the foregoing method implementations.

Optionally, the communication apparatus 170 further includes at least one memory 1730. The memory 1730 is used to store program instructions and/or data. The memory 1730 and the processor 1720 are coupled with each other. The coupling of implementations of the disclosure may be indirect coupling or communication connection between devices, units, or modules, may be in the form of electrical, mechanical, etc., and is used for information exchange between devices, units, or modules. The processor 1720 may cooperate with the memory 1730. The processor 1720 can execute program instructions stored in the memory 1730. At least one of the at least one memory may be contained in the processor.

The specific connection media among the transceiver 1710, the processor 1720, and the memory 1730 is not limited in implementations of the disclosure. In implementations of the disclosure, in FIG. 17, the memory 1730, the processor 1720, and the transceiver 1710 are connected through a bus 1740. The bus is represented by a thick line in FIG. 17. The connection among other components is merely illustrative and not limited herein. The bus may include address bus, data bus, control bus, etc. For ease of representation, only one thick line is used in FIG. 17, but it does not mean that there is only one bus or one type of bus.

In implementations of the disclosure, the processor may be a general-purpose processor, a digital signal processor, an application specific integrated circuit, a field-programmable gate array or other programmable logic devices, a discrete gate or a transistor logic device, a discrete hardware component, etc. The processor can implement or execute the methods, operations, and logic blocks disclosed in implementations of the disclosure. The general-purpose processor may be a microprocessor or any conventional processor. The operations of the method disclosed in implementations of the disclosure may be directly performed by a hardware processor, or performed by a combination of hardware and software modules in the processor.

FIG. 18 is a schematic structural diagram illustrating a communication apparatus 180 provided in other implementations of the disclosure. As illustrated in FIG. 18, the communication apparatus includes a logic circuit 1801 and an interface 1802. The processing module in FIG. 7 to FIG. 16 can be implemented using the logic circuit 1801, and the transceiver module in FIG. 7 to FIG. 16 can be implemented using interface 1802. The logic circuit 1801 may be a chip, a processing circuit, an integrated circuit, or system on chip (SoC), etc. The interface 1802 may be a communication interface, input/output interface, etc. In implementations of the disclosure, the logic circuit and the interface can also be coupled with each other. The specific connection of the logic circuit and the interface is not limited in implementations of the disclosure.

In some implementations of the disclosure, the logic circuit and the interface may be configured to implement the functions or operations performed by the above UE.

In other implementations of the disclosure, the logic circuit and the interface may be configured to implement the functions or operations performed by the above base station.

The disclosure further provides a non-transitory computer-readable storage medium. The non-transitory computer-readable storage medium stores computer codes which, when run on a computer, cause the computer to execute the method in the foregoing implementations.

The disclosure further provides a computer program product. The computer program product includes computer codes or computer programs which, when run on a computer, are operable to execute the communication method in the foregoing implementations.

The disclosure further provides a communication system. The communication system includes the above terminal device and the above base station.

Implementations of the disclosure provide communication methods and communication apparatuses, to achieve network energy saving.

In a first aspect, implementations of the disclosure provide a communication method. The communication method includes: receiving, within one period of a synchronization signal burst, N1 synchronization signal bursts, N/being an integer greater than 1.

In implementations of the disclosure, a UE receives N1 synchronization signal bursts within one period of a synchronization signal burst. As such, the UE only needs to wake up within one period to process the N1 synchronization signal bursts for time-frequency synchronization, thereby reducing power consumption.

In an implementation, a period of the N1 synchronization signal bursts within one period of the synchronization signal burst is a first period, and the first period is less than the period of the synchronization signal burst.

In an implementation, the first period is greater than or equal to 5 milliseconds.

In an implementation, the first period is greater than or equal to 10 milliseconds.

In an implementation, the communication method further includes: performing time-frequency synchronization with the N1 synchronization signal bursts.

In an implementation, the communication method further includes: receiving first configuration information, where the first configuration information is used for configuring the UE to receive the N1 synchronization signal bursts within one period of the synchronization signal burst. For example, a device at base station side sends the first configuration information to the UE through higher layer signaling, and the UE receives the synchronization signal bursts according to the first configuration information.

In a second aspect, implementations of the disclosure provide a communication method. The communication method includes: receiving, within one period of a synchronization signal burst, N2 synchronization signal bursts and N3 reference signal bursts, N2 being an integer greater than or equal to 0, and N3 being an integer greater than 0.

In implementations of the disclosure, the UE receives N2 synchronization signal bursts and N3 reference signal bursts within one period of a synchronization signal burst. As such, the UE only needs to wake up within one period to process the N2 synchronization signal bursts and the N3 reference signal bursts for AGC, time-frequency synchronization (time/frequency tracking), and RRM measurement, thereby reducing power consumption.

In an implementation, the sum of N2 and N3 is an integer greater than 1.

In an implementation, the sum of N2 and N3 is 3, and N3 is 3, 2, or 1.

In an implementation, a period of the N2 synchronization signal bursts within one period of the synchronization signal burst is a second period, and the second period is less than the period of the synchronization signal burst.

In an implementation, the second period is greater than or equal to 5 milliseconds.

In an implementation, the second period is greater than or equal to 10 milliseconds.

In an implementation, a period of the N3 reference signal bursts within one period of the synchronization signal burst is a third period, and the third period is less than the period of the synchronization signal burst.

In an implementation, the third period is greater than or equal to 5 milliseconds.

In an implementation, the third period is greater than or equal to 10 milliseconds.

In an implementation, a period of the N3 reference signal bursts is a period of the synchronization signal burst.

In an implementation, the N3 reference signal bursts are located after the N2 synchronization signal bursts.

In an implementation, indexes of slots corresponding to the N3 reference signal bursts are greater than an index of the last slot of the N2 synchronization signal bursts.

In an implementation, offsets of the N3 reference signal bursts satisfy: indexes of slots corresponding to the N3 reference signal bursts being greater than an index of the last slot of the N2 synchronization signal bursts.

In an implementation, gaps between indexes of slots corresponding to the N3 reference signal bursts and an index of the last slot of the N2 synchronization signal bursts are greater than a first gap.

In an implementation, offsets of the N3 reference signal bursts satisfy: gaps between indexes of slots corresponding to the N3 reference signal bursts and an index of the last slot of the N2 synchronization signal bursts being greater than a first gap.

In an implementation, the first gap corresponds to UE capability.

In an implementation, the last slot of the N2 synchronization signal bursts is the last slot containing a candidate SSB position.

In an implementation, the last slot of the N2 synchronization signal bursts is the last slot containing a position of an actual transmitted SSB.

In an implementation, the last slot of the N2 synchronization signal bursts is the last slot in a half frame where the synchronization signal burst is located.

In an implementation, the N3 reference signal bursts include one or two of a PBCH DMRS and a TRS.

In an implementation, the communication method further includes: performing AGC and time-frequency synchronization with the N2 synchronization signal bursts, and/or performing RRM measurement with the N3 reference signal bursts.

In an implementation, the communication method further includes: receiving second configuration information, where the second configuration information is used for configuring the UE to receive the N2 synchronization signal bursts and the N3 reference signal bursts within one period of the synchronization signal burst. For example, a device at base station side sends the second configuration information to the UE through higher layer signaling, and the UE receives the synchronization signal bursts and the reference signal bursts according to the second configuration information.

In a third aspect, implementations of the disclosure provide a communication method. The communication method includes: receiving a reference signal burst and a synchronization signal burst, a period of the reference signal burst being equal to a period of the synchronization signal burst.

In an implementation, an offset of the reference signal burst is not equal to an offset of the synchronization signal burst.

In an implementation, an index of a slot corresponding to the reference signal burst is greater than an index of the last slot of the synchronization signal burst.

In an implementation, an offset of the reference signal burst satisfies: an index of a slot corresponding to the reference signal burst being greater than an index of the last slot of the synchronization signal burst.

In an implementation, a gap between an index of a slot corresponding to the reference signal burst and an index of the last slot of the synchronization signal burst is greater than a first gap.

In an implementation, an offset of the reference signal burst satisfies: a gap between an index of a slot corresponding to the reference signal burst and an index of the last slot of the synchronization signal burst being greater than a first gap.

In an implementation, the first gap corresponds to UE capability.

In an implementation, the last slot of the synchronization signal burst is the last slot containing a candidate SSB position.

In an implementation, the last slot of the synchronization signal burst is the last slot containing a position of an actual transmitted SSB.

In an implementation, the last slot of the synchronization signal burst is the last slot in a half frame where the synchronization signal burst is located.

In an implementation, the reference signal burst includes one or two of a PBCH DMRS and a TRS.

In a fourth aspect, implementations of the disclosure provide a communication method. The communication method includes: receiving, within one period of a reference signal burst, N4 reference signal bursts, N4 being an integer greater than 1.

In implementations of the disclosure, a UE receives N4 reference signal bursts within one period of a reference signal burst. As such, the UE only needs to wake up within one period to process the N4 reference signal bursts for RRM measurement, thereby reducing power consumption.

In an implementation, a period of the N4 reference signal bursts within one period of the reference signal burst is a fourth period, and the fourth period is less than the period of the reference signal burst.

In an implementation, the fourth period is greater than or equal to 5 milliseconds.

In an implementation, the fourth period is greater than or equal to 10 milliseconds.

In an implementation, the N4 reference signal bursts include one or two of a PBCH DMRS and a TRS.

In an implementation, the communication method further includes: performing RRM measurement with the N4 reference signal bursts.

In an implementation, the communication method further includes: receiving third configuration information, where the third configuration information is used for configuring the UE to receive the N4 reference signal bursts within one period of the reference signal burst. For example, a device at base station side sends the third configuration information to the UE through higher layer signaling, and the UE receives the reference signal bursts according to the third configuration information.

In a fifth aspect, implementations of the disclosure provide a communication method. The communication method includes: determining that a synchronization signal burst and/or a reference signal burst within a first window are valid.

The term “valid” herein means exsitance, that is, something has been sent by a base station. Or, in other words, a synchronization signal burst and/or a reference signal burst are sent by the base station within the first window.

In implementations of the disclosure, the UE determines that a synchronization signal burst and/or a reference signal burst within a first window are valid, and only needs to receive the synchronization signal burst and/or the reference signal burst within the first window. As such, the UE does not need to receive the synchronization signal burst and/or the reference signal burst outside the first window, thereby reducing power consumption.

In an implementation, the first window corresponds to SMTC.

In an implementation, one or more of a period, an offset, and a window length of the first window are configurable.

In an implementation, determining that the synchronization signal burst and/or the reference signal burst within the first window are valid includes: determining to receive N1 synchronization signal bursts within the first window, N1 being an integer greater than 1. For example, the first window is one period of a synchronization signal burst, within the first window, N1 synchronization signal bursts can be received.

In an implementation, determining that the synchronization signal burst and/or the reference signal burst within the first window are valid includes: determining to receive N2 synchronization signal bursts and N3 reference signal bursts within the first window, N2 being an integer greater than or equal to 0, and N3 being an integer greater than 0. For example, the first window is one period of a synchronization signal burst, within the first window, N2 synchronization signal bursts and N3 reference signal bursts can be received.

In an implementation, determining that the synchronization signal burst and/or the reference signal burst within the first window are valid includes: determining to receive N4 reference signal bursts within the first window, N4 being an integer greater than 1. For example, the first window is one period of a reference signal burst, within the first window, N4 reference signal bursts can be received.

In an implementation, the communication method further includes: receiving first configuration information. Determining that the synchronization signal burst and/or the reference signal burst within the first window are valid includes: determining to receive N1 synchronization signal bursts within the first window according to the first configuration information, N1 being an integer greater than 1.

In an implementation, the communication method further includes: receiving second configuration information. Determining that the synchronization signal burst and/or the reference signal burst within the first window are valid includes: determining to receive N2 synchronization signal bursts and N3 reference signal bursts within the first window according to the second configuration information, N2 being an integer greater than or equal to 0, and N3 being an integer greater than 0.

In an implementation, the communication method further includes: receiving third configuration information. Determining that the synchronization signal burst and/or the reference signal burst within the first window are valid includes: determining to receive N4 reference signal bursts within the first window according to the third configuration information, N4 being an integer greater than 1.

In a sixth aspect, implementations of the disclosure provide a communication method. The communication method includes: sending, within one period of a synchronization signal burst, N1 synchronization signal bursts, N/being an integer greater than 1.

In implementations of the disclosure, N1 synchronization signal bursts are sent within one period of a synchronization signal burst. As such, the UE only needs to wake up within one period to process the N1 synchronization signal bursts for time-frequency synchronization, thereby reducing power consumption.

In an implementation, a period of the N1 synchronization signal bursts within one period of the synchronization signal burst is a first period, and the first period is less than the period of the synchronization signal burst.

In an implementation, the first period is greater than or equal to 5 milliseconds.

In an implementation, the first period is greater than or equal to 10 milliseconds.

In an implementation, the communication method further includes: sending first configuration information, where the first configuration information is used for configuring the UE to receive the N1 synchronization signal bursts within one period of the synchronization signal burst.

In a seventh aspect, implementations of the disclosure provide a communication method. The communication method includes: sending, within one period of a synchronization signal burst, N2 synchronization signal bursts and N3 reference signal bursts, N2 being an integer greater than or equal to 0, and N3 being an integer greater than 0.

In implementations of the disclosure, N2 synchronization signal bursts and N3 reference signal bursts are sent within one period of a synchronization signal burst. As such, the UE only needs to wake up within one period to process the N2 synchronization signal bursts and the N3 reference signal bursts for AGC, time-frequency synchronization, and RRM measurement, thereby reducing power consumption.

In an implementation, the sum of N2 and N3 is an integer greater than 1.

In an implementation, the sum of N2 and N3 is 3, and N3 is 3, 2, or 1.

In an implementation, a period of the N2 synchronization signal bursts within one period of the synchronization signal burst is a second period, and the second period is less than the period of the synchronization signal burst.

In an implementation, the second period is greater than or equal to 5 milliseconds.

In an implementation, the second period is greater than or equal to 10 milliseconds.

In an implementation, a period of the N3 reference signal bursts within one period of the synchronization signal burst is a third period, and the third period is less than the period of the synchronization signal burst.

In an implementation, the third period is greater than or equal to 5 milliseconds.

In an implementation, the third period is greater than or equal to 10 milliseconds.

In an implementation, a period of the N3 reference signal bursts is a period of the synchronization signal burst.

In an implementation, the N3 reference signal bursts are located after the N2 synchronization signal bursts.

In an implementation, indexes of slots corresponding to the N3 reference signal bursts are greater than an index of the last slot of the N2 synchronization signal bursts.

In an implementation, offsets of the N3 reference signal bursts satisfy: indexes of slots corresponding to the N3 reference signal bursts being greater than an index of the last slot of the N2 synchronization signal bursts.

In an implementation, gaps between indexes of slots corresponding to the N3 reference signal bursts and an index of the last slot of the N2 synchronization signal bursts are greater than a first gap.

In an implementation, offsets of the N3 reference signal bursts satisfy: gaps between indexes of slots corresponding to the N3 reference signal bursts and an index of the last slot of the N2 synchronization signal bursts being greater than a first gap.

In an implementation, the first gap corresponds to UE capability.

In an implementation, the last slot of the N2 synchronization signal bursts is the last slot containing a candidate SSB position.

In an implementation, the last slot of the N2 synchronization signal bursts is the last slot containing a position of an actual transmitted SSB.

In an implementation, the last slot of the N2 synchronization signal bursts is the last slot in a half frame where the synchronization signal burst is located.

In an implementation, the N3 reference signal bursts include one or two of a PBCH DMRS and a TRS.

In an implementation, the communication method further includes: sending second configuration information, where the second configuration information is used for configuring the UE to receive the N2 synchronization signal bursts and the N3 reference signal bursts within one period of the synchronization signal burst.

In an eighth aspect, implementations of the disclosure provide a communication method. The communication method includes: sending a reference signal burst and a synchronization signal burst, a period of the reference signal burst being equal to a period of the synchronization signal burst.

In an implementation, an offset of the reference signal burst is not equal to an offset of the synchronization signal burst.

In an implementation, an index of a slot corresponding to the reference signal burst is greater than an index of the last slot of the synchronization signal burst.

In an implementation, an offset of the reference signal burst satisfies: an index of a slot corresponding to the reference signal burst being greater than an index of the last slot of the synchronization signal burst.

In an implementation, a gap between an index of a slot corresponding to the reference signal burst and an index of the last slot of the synchronization signal burst is greater than a first gap.

In an implementation, an offset of the reference signal burst satisfies: a gap between an index of a slot corresponding to the reference signal burst and an index of the last slot of the synchronization signal burst being greater than a first gap.

In an implementation, the first gap corresponds to UE capability.

In an implementation, the last slot of the synchronization signal burst is the last slot containing a candidate SSB position.

In an implementation, the last slot of the synchronization signal burst is the last slot containing a position of an actual transmitted SSB.

In an implementation, the last slot of the synchronization signal burst is the last slot in a half frame where the synchronization signal burst is located.

In an implementation, the reference signal burst includes one or two of a PBCH DMRS and a TRS.

In a ninth aspect, implementations of the disclosure provide a communication method. The communication method includes: sending, within one period of a reference signal burst, N4 reference signal bursts, N4 being an integer greater than 1.

In implementations of the disclosure, N4 reference signal bursts are sent within one period of a reference signal burst. As such, the UE only needs to wake up within one period to process the N4 reference signal bursts for RRM measurement, thereby reducing power consumption.

In an implementation, a period of the N4 reference signal bursts within one period of the reference signal burst is a fourth period, and the fourth period is less than the period of the reference signal burst.

In an implementation, the fourth period is greater than or equal to 5 milliseconds.

In an implementation, the fourth period is greater than or equal to 10 milliseconds.

In an implementation, the N4 reference signal bursts include one or two of a PBCH DMRS and a TRS.

In an implementation, the communication method further includes: sending third configuration information, where the third configuration information is used for configuring the UE to receive the N4 reference signal bursts within one period of the reference signal burst.

In a tenth aspect, implementations of the disclosure provide a communication method. The communication method includes: sending, within a first window, a synchronization signal burst and/or a reference signal burst.

In implementations of the disclosure, a synchronization signal burst and/or a reference signal burst are sent within the first window, and the UE only needs to receive the synchronization signal burst and/or the reference signal burst within the first window. That is, the UE does not need to receive the synchronization signal burst and/or the reference signal burst outside the first window, thereby reducing power consumption.

In an implementation, the first window corresponds to SMTC.

In an implementation, one or more of a period, an offset, and a window length of the first window are configurable.

In an implementation, sending the synchronization signal burst and/or the reference signal burst within the first window includes: within the first window, sending N1 synchronization signal bursts, N1 being an integer greater than 1.

In an implementation, sending the synchronization signal burst and/or the reference signal burst within the first window includes: within the first window, sending N2 synchronization signal bursts and N3 reference signal bursts, N2 being an integer greater than or equal to 0, and N3 being an integer greater than 0.

In an implementation, sending the synchronization signal burst and/or the reference signal burst within the first window includes: within the first window, sending N4 reference signal bursts, N4 being an integer greater than 1.

In an implementation, the communication method further includes: sending first configuration information, where the first configuration information is used for configuring the UE to receive the N1 synchronization signal bursts within the first window.

In an implementation, the communication method further includes: sending second configuration information, where the second configuration information is used for configuring the UE to receive the N2 synchronization signal bursts and the N3 reference signal bursts within the first window.

In an implementation, the communication method further includes: sending third configuration information, where the third configuration information is used for configuring the UE to receive the N4 reference signal bursts within the first window.

In an eleventh aspect, implementations of the disclosure provide a communication apparatus. The communication apparatus has functions of implementing the operations of the method implementations in the first aspect. These functions can be implemented through hardware, or can also be implemented by executing corresponding software through hardware. The hardware or software includes one or more modules corresponding to the above functions. In an implementation, the communication apparatus includes a transceiver module, the transceiver module is configured to receive, within one period of a synchronization signal burst, N1 synchronization signal bursts, N/being an integer greater than 1.

In a twelfth aspect, implementations of the disclosure provide a communication apparatus. The communication apparatus has functions of implementing the operations of the method implementations in the second aspect. These functions can be implemented through hardware, or can also be implemented by executing corresponding software through hardware. The hardware or software includes one or more modules corresponding to the above functions. In an implementation, the communication apparatus includes a transceiver module, the transceiver module is configured to receive, within one period of a synchronization signal burst, N2 synchronization signal bursts and N3 reference signal bursts, N2 being an integer greater than or equal to 0, and N3 being an integer greater than 0.

In a thirteenth aspect, implementations of the disclosure provide a communication apparatus. The communication apparatus has functions of implementing the operations of the method implementations in the third aspect. These functions can be implemented through hardware, or can also be implemented by executing corresponding software through hardware. The hardware or software includes one or more modules corresponding to the above functions.

In an implementation, the communication apparatus includes a transceiver module, the transceiver module is configured to receive a reference signal burst and a synchronization signal burst, a period of the reference signal burst being equal to a period of the synchronization signal burst.

In a fourteenth aspect, implementations of the disclosure provide a communication apparatus. The communication apparatus has functions of implementing the operations of the method implementations in the fourth aspect. These functions can be implemented through hardware, or can also be implemented by executing corresponding software through hardware. The hardware or software includes one or more modules corresponding to the above functions. In an implementation, the communication apparatus includes a transceiver module, the transceiver module is configured to receive, within one period of a reference signal burst, N4 reference signal bursts, N4 being an integer greater than 1.

In a fifteenth aspect, implementations of the disclosure provide a communication apparatus. The communication apparatus has functions of implementing the operations of the method implementations in the fifth aspect. These functions can be implemented through hardware, or can also be implemented by executing corresponding software through hardware. The hardware or software includes one or more modules corresponding to the above functions. In an implementation, the communication apparatus includes a processing module, the processing module is configured to determine that a synchronization signal burst and/or a reference signal burst within a first window are valid.

In a sixteenth aspect, implementations of the disclosure provide a communication apparatus. The communication apparatus has functions of implementing the operations of the method implementations in the sixth aspect. These functions can be implemented through hardware, or can also be implemented by executing corresponding software through hardware. The hardware or software includes one or more modules corresponding to the above functions. In an implementation, the communication apparatus includes a transceiver module, the transceiver module is configured to send, within one period of a synchronization signal bursts, N1 synchronization signal bursts, N1 being an integer greater than 1.

In a seventeenth aspect, implementations of the disclosure provide a communication apparatus. The communication apparatus has functions of implementing the operations of the method implementations in the seventh aspect. These functions can be implemented through hardware, or can also be implemented by executing corresponding software through hardware. The hardware or software includes one or more modules corresponding to the above functions. In an implementation, the communication apparatus includes a transceiver module, the transceiver module is configured to send, within one period of a synchronization signal burst, N2 synchronization signal bursts and N3 reference signal bursts, N2 being an integer greater than or equal to 0, and N3 being an integer greater than 0.

In an eighteenth aspect, implementations of the disclosure provide a communication apparatus. The communication apparatus has functions of implementing the operations of the method implementations in the eighth aspect. These functions can be implemented through hardware, or can also be implemented by executing corresponding software through hardware. The hardware or software includes one or more modules corresponding to the above functions. In an implementation, the communication apparatus includes a transceiver module, the transceiver module is configured to send a reference signal burst and a synchronization signal burst, a period of the reference signal burst being equal to a period of the synchronization signal burst.

In a nineteenth aspect, implementations of the disclosure provide a communication apparatus. The communication apparatus has functions of implementing the operations of the method implementations in the ninth aspect. These functions can be implemented through hardware, or can also be implemented by executing corresponding software through hardware. The hardware or software includes one or more modules corresponding to the above functions. In an implementation, the communication apparatus includes a transceiver module, the transceiver module is configured to send, within one period of a reference signal burst, N4 reference signal bursts, N4 being an integer greater than 1.

In a twentieth aspect, implementations of the disclosure provide a communication apparatus. The communication apparatus has functions of implementing the operations of the method implementations in the tenth aspect. These functions can be implemented through hardware, or can also be implemented by executing corresponding software through hardware. The hardware or software includes one or more modules corresponding to the above functions. In an implementation, the communication apparatus includes a transceiver module, the transceiver module is configured to send, within a first window, a synchronization signal burst and/or a reference signal burst.

In a twenty-first aspect, implementations of the disclosure provide a communication apparatus. The communication apparatus includes a processor. The processor is configured to execute computer execution instructions stored in a memory to cause execution of the method in the first aspect and any possible implementation thereof, or execution of the method in the second aspect and any possible implementation thereof, or execution of the method in the third aspect and any possible implementation thereof, or execution of the method in the fourth aspect and any possible implementation thereof, or execution of the method in the fifth aspect and any possible implementation thereof, or execution of the method in the sixth aspect and any possible implementation thereof, or execution of the method in the seventh aspect and any possible implementation thereof, or execution of the method in the eighth aspect and any possible implementation thereof, or execution of the method in the ninth aspect and any possible implementation thereof, or execution of the method in the tenth aspect and any possible implementation thereof.

In implementations of the disclosure, during execution of the above method, a process of sending information in the above method can be understood as a process of outputting information based on an instruction from the processor. When outputting information, the processor outputs the information to a transceiver for transmission. After the information is outputted by the processor, the information may undergo other processing before reaching the transceiver. Similarly, when the processor receives input information, the transceiver receives the information and inputs the information into the processor. Further, after the transceiver receives the information, the information may undergo other processing before being inputted into the processor.

For the operations involved in the processor such as sending and/or receiving, if there is no special explanation or these operations do not conflict with theirs actual function or internal logic in the relevant description, these operations can be generally understood as instruction output based on the processor.

In an implementation process, the processor may be a processor specifically designed to execute these methods, or may be a processor configured to execute these methods by executing computer instructions in a memory, such as a general-purpose processor. For example, the processor may also be configured to execute programs stored in the memory. The programs, when executed, cause the communication apparatus to execute the method in the first aspect and any possible implementation thereof.

In an implementation, the memory is located outside the communication apparatus.

In an implementation, the memory is located within the communication apparatus.

In implementations of the disclosure, the processor and the memory may also be integrated into one device, that is, the processor and the memory may also be integrated together.

In an implementation, the communication apparatus further includes a transceiver. The transceiver is configured to receive or send a message.

In a twenty-second aspect, the disclosure provides a communication apparatus. The communication apparatus includes a processing circuit and an interface circuit. The interface circuit is configured to obtain or output data. The processing circuit is configured to execute the corresponding method in the first aspect and any possible implementation thereof, or execute the corresponding method in the second aspect and any possible implementation thereof, or execute the corresponding method in the third aspect and any possible implementation thereof, or execute the corresponding method in the fourth aspect and any possible implementation thereof, or execute the corresponding method in the fifth aspect and any possible implementation thereof, or execute the corresponding method in the sixth aspect and any possible implementation thereof, or execute the corresponding method in the seventh aspect and any possible implementation thereof, or execute the corresponding method in the eighth aspect and any possible implementation thereof, or execute the corresponding method in the ninth aspect or any possible implementation thereof, or execute the corresponding method in the tenth aspect or any possible implementation thereof.

In a twenty-third aspect, the disclosure provides a computer-readable storage medium. The computer-readable storage medium stores computer programs which, when run on a computer, are operable to execute the method in the first aspect and any possible implementation thereof, or execute the method in the second aspect and any possible implementation thereof, or execute the method in the third aspect and any possible implementation thereof, or execute the method in the fourth aspect and any possible implementation thereof, or execute the method in the fifth aspect and any possible implementation thereof, or execute the method in the sixth aspect and any possible implementation thereof, or execute the method in the seventh aspect and any possible implementation thereof, or execute the method in the eighth aspect and any possible implementation thereof, or execute the method in the ninth aspect and any possible implementation thereof, or execute the method in the tenth aspect and any possible implementation thereof.

In a twenty-fourth aspect, the disclosure provides a computer program product. The computer program product contains computer programs or computer codes which, when run on a computer, are operable to execute the method in the first aspect and any possible implementation thereof, or execute the method in the second aspect and any possible implementation thereof, or execute the method in the third aspect and any possible implementation thereof, or execute the method in the fourth aspect and any possible implementation thereof, or execute the method in the fifth aspect and any possible implementation thereof, or execute the method in the sixth aspect and any possible implementation thereof, or execute the method in the seventh aspect and any possible implementation thereof, or execute the method in the eighth aspect and any possible implementation thereof, or execute the method in the ninth aspect and any possible implementation thereof, or execute the method in the tenth aspect and any possible implementation thereof.

The above merely depicts some exemplary implementations of the disclosure, but the protection scope of the disclosure is not limited to these exemplary implementations. Any easily thought of changes or equivalent substitutions made by those of ordinary skill in the art without departing from the scope of technology of the disclosure shall be encompassed within the protection scope of the disclosure. Therefore, the protection scope of the disclosure shall be based on the scope of the appended claims.

1. A communication method, performed by a user equipment (UE) and comprising:
receiving, within one period of a synchronization signal burst, N1 synchronization signal bursts, N1 being an integer greater than 1.

2. The communication method of claim 1, wherein a period of the N1 synchronization signal bursts within one period of the synchronization signal burst is a first period, and the first period is less than the period of the synchronization signal burst.

3. The communication method of claim 2, wherein the first period is greater than or equal to 5 milliseconds.

4. The communication method of claim 2, wherein the first period is greater than or equal to 10 milliseconds.

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. A communication method, performed by a user equipment (UE) and comprising:
determining that a synchronization signal burst and/or a reference signal burst within a first window are valid.

31. The communication method of claim 30, wherein the first window corresponds to synchronization measurement timing configuration (SMTC).

32. The communication method of claim 30, wherein one or more of a period, an offset, and a window length of the first window are configurable.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. A communication apparatus, comprising:
a transceiver,
a processor, in communication connection with the transceiver; and
a memory, in communication connection with the processor and storing instructions executable by the processor;
the instructions, when executed by the processor, being operable with the processor to:
cause the transceiver to receive, within one period of a synchronization signal burst, N1 synchronization signal bursts, N1 being an integer greater than 1.

50. The communication apparatus of claim 49, wherein a period of the N1 synchronization signal bursts within one period of the synchronization signal burst is a first period, and the first period is less than the period of the synchronization signal burst.

51. The communication apparatus of claim 50, wherein the first period is greater than or equal to 5 milliseconds.

52. The communication apparatus of claim 50, wherein the first period is greater than or equal to 10 milliseconds.
